(19) United States
(12) Patent Application Publication
(10) Pub. No.: US 2025/0032852 A1
(43) Pub. Date: Jan. 30, 2025

(54) WEARABLE ELECTRONIC DEVICE DISPLAYING VIRTUAL OBJECT, OPERATION METHOD THEREOF, AND RECORDING MEDIUM

(71) Applicant: Samsung Electronics Co., Ltd., Suwon-si (KR)

(72) Inventors: Yoonho LEE, Suwon-si (KR); Hyunsoo KIM, Suwon-si (KR); Myoungwoo NAM, Suwon-si (KR); Jeaguk SHIM, Suwon-si (KR); Nagyeom YOO, Suwon-si (KR); Sunghoon YIM, Suwon-si (KR)

(21) Appl. No.: 18/782,640

(22) Filed: Jul. 24, 2024

Related U.S. Application Data
(63) Continuation of application No. PCT/KR2024/010632, filed on Jul. 23, 2024.

(30) Foreign Application Priority Data
Jul. 25, 2023 (KR) 10-2023-0096795
Sep. 22, 2023 (KR) 10-2023-0127255

(51) Int. Cl. A63B 24/00; A63B 71/06

(52) U.S. Cl. CPC A63B 24/0006; A63B 71/0622; A63B 2024/0015; A63B 2071/0636

(57) ABSTRACT

According to an embodiment, a wearable electronic device may comprise a camera, a display, communication circuitry, and a processor. The processor may obtain a first image captured by an external electronic device from the external electronic device through the communication circuitry, the first image including an image captured for body portions of a user wearing the wearable electronic device, obtain exercise information about designated exercise postures using the body portions, obtaining a second image through the camera, based on identifying that the user's first body portion is positioned in a field of view (FOV) area of the camera using the first image and the second image, display, through the display, a first virtual object indicating a first designated exercise posture related to the first body portion among the designated exercise postures on a first area of the second image corresponding to the user's first body portion, identify whether the first designated exercise posture matches a first posture of the first body portion of the user, display first feedback information to correct the first posture using the first virtual object, based on identifying that the first designated exercise posture does not match the first posture, and display second feedback information indicating that the first posture matches the first designated exercise posture using the first virtual object, based on identifying that the first designated exercise posture matches the first posture.

### CROSS-REFERENCE TO RELATED APPLICATION(S)

This application is a continuation application, claiming priority under § 365(c), of an International application No. PCT/KR2024/010632, filed on Jul. 23, 2024, which is based on and claims the benefit of a Korean patent application number 10-2023-0096795, filed on Jul. 25, 2023, in the Korean Intellectual Property Office, and of a Korean patent application number 10-2023-0127255, filed on Sep. 22, 2023, in the Korean Intellectual Property Office, the disclosure of each of which is incorporated by reference herein in its entirety.

### BACKGROUND

### 1. Field

The disclosure relates to a wearable electronic device displaying virtual objects, an operation method thereof, and a recording medium.

### 2. Description of Related Art

An increasing number of services and additional features are being offered through wearable electronic devices such as augmented reality glasses (AR glasses), video see through (VST) devices, and head mounted display (HMD) devices. To meet the needs of various users and raise use efficiency of electronic devices, communication service carriers or device manufacturers are jumping into competitions to develop electronic devices with differentiated and diversified functionalities. Accordingly, various functions that are provided through wearable electronic devices are evolving more and more.

AR glasses or a VST device, when worn on the user's body, may provide a realistic experience to the user by displaying virtual images. AR glasses or a VST device can replace the usability of smartphones in a variety of areas, such as gaming entertainment, education, and social networking services. Through VST glasses or a VST device, users may be provided with life-like content and interact with it to feel like they are in a virtual world.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a wearable electronic device displaying virtual objects, an operation method thereof, and a recording medium.

Additional aspects will be set forth in part in the description which follows and, in part, will be apparent from the description, or may be learned by practice of the presented embodiments.

According to an embodiment, a wearable electronic device may comprise memory storing instructions, a camera, a display, communication circuitry, and a processor.

According to an embodiment, the wearable electronic device may obtain a first image captured by an external electronic device from the external electronic device through the communication circuitry.

According to an embodiment, the first image may include an image captured for body portions of a user wearing the wearable electronic device.

According to an embodiment, the wearable electronic device may obtain exercise information about designated exercise postures using the body portions.

According to an embodiment, the wearable electronic device may obtain a second image through the camera.

According to an embodiment, the second image may include at least one body portion among the user's body portions.

According to an embodiment, the wearable electronic device may display, through the display, a first virtual object indicating a first designated exercise posture related to the first body portion among the designated exercise postures on a first area of the second image corresponding to the first body portion of the user, based on identifying that the user's first body portion is positioned in a field of view (FOV) area of the camera using the first image and the second image.

According to an embodiment, the wearable electronic device may identify whether the first designated exercise posture matches a first posture of the first body portion of the user.

According to an embodiment, the wearable electronic device may display, through the display, first feedback information to correct the first posture using the first virtual object, based on identifying that the first designated exercise posture does not match the first posture.

According to an embodiment, the wearable electronic device may display, through the display, second feedback information indicating that the first posture matches the first designated exercise posture using the first virtual object, based on identifying that the first designated exercise posture matches the first posture.

According to an embodiment, a method for operating a wearable electronic device may comprise obtaining a first image captured by an external electronic device from the external electronic device.

According to an embodiment, in the method for operating the wearable electronic device, the first image may include an image captured for body portions of a user wearing the wearable electronic device.

According to an embodiment, the method for operating the wearable electronic device may comprise obtaining exercise information about designated exercise postures using the body portions from the external electronic device.

According to an embodiment, the method for operating the wearable electronic device may comprise obtaining a second image through a camera included in the wearable electronic device.

According to an embodiment, the method for operating the wearable electronic device may comprise displaying a first virtual object indicating a first designated exercise posture related to the first body portion among the designated exercise postures on a first area of the second image corresponding to the first body portion of the user, based on identifying that the user's first body portion is positioned in a field of view (FOV) area of the camera using the first image and the second image.

According to an embodiment, the method for operating the wearable electronic device may comprise identifying whether the first designated exercise posture matches a first posture of the first body portion of the user.

According to an embodiment, the method for operating the wearable electronic device may comprise displaying, through the display, first feedback information to correct the first posture using the first virtual object, based on identifying that the first designated exercise posture does not match the first posture.

According to an embodiment, the method for operating the wearable electronic device may comprise displaying, through the display, second feedback information indicating that the first posture matches the first designated exercise posture using the first virtual object, based on identifying that the first designated exercise posture matches the first posture.

According to an embodiment, a storage medium storing computer-readable instructions, the instructions, when executed by at least one processor of a wearable electronic device individually or collectively, cause the wearable electronic device to perform operations, the operations comprising: obtaining a first image captured by an external electronic device from the external electronic device, wherein the first image includes an image captured for body portions of a user wearing the wearable electronic device, obtaining exercise information about designated exercise postures using the body portions, obtaining a second image through a camera included in the wearable electronic device, wherein the second image includes at least one body portion among the user's body portions, based on identifying that a first body portion of the user is positioned in a field of view (FOV) area of the camera using the first image and the second image, displaying, through a display included in the wearable electronic device, a first virtual object indicating a first designated exercise posture related to the first body portion among the designated exercise postures on a first area of the second image corresponding to the first body portion of the user, identifying whether the first designated exercise posture matches a first posture of the first body portion of the user, displaying, through the display, first feedback information to correct the first posture using the first virtual object, based on identifying that the first designated exercise posture does not match the first posture, and displaying, through the display, second feedback information indicating that the first posture matches the first designated exercise posture using the first virtual object, based on identifying that the first designated exercise posture matches the first posture.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an electronic device in a network environment according to various embodiments;

FIG. 2 is a perspective view illustrating an internal configuration of a wearable electronic device according to an embodiment of the disclosure;

FIGS. 3A and 3B are views illustrating front and rear surfaces of a wearable electronic device according to an embodiment;

FIG. 4 is a view illustrating a system including a wearable electronic device and an external electronic device according to an embodiment;

FIG. 5 is a block diagram schematically illustrating a system including a wearable electronic device and an external electronic device according to an embodiment;

FIG. 6 is a flowchart illustrating an operation of displaying a first image by a wearable electronic device according to an embodiment;

FIG. 7A is a flowchart illustrating an operation of displaying a first virtual object indicating a first designated exercise posture on a first body portion positioned in an FOV area by a wearable electronic device according to an embodiment;

FIG. 7B is a flowchart illustrating an operation of displaying a second virtual object indicating a second designated exercise posture on a second body portion positioned in an area other than an FOV area by a wearable electronic device according to an embodiment;

FIG. 8 is a flowchart illustrating an operation of displaying a second image to which a visual effect is applied by a wearable electronic device according to an embodiment;

FIG. 9A is a flowchart illustrating an operation of adjusting a moving speed of a first designated posture by a wearable electronic device according to an embodiment;

FIG. 9B is a flowchart illustrating an operation of outputting sound or vibration based on a first matching degree by a wearable electronic device according to an embodiment;

FIG. 10 is a view illustrating an operation of obtaining an image captured for body portions of a user wearing a wearable electronic device, by an external electronic device according to an embodiment;

FIG. 11A is a view illustrating an operation of displaying feedback information using a first virtual object by a wearable electronic device according to an embodiment;

FIG. 11B is a view illustrating an operation of displaying feedback information using a first virtual object by a wearable electronic device according to an embodiment;

FIG. 12 is a view illustrating an operation of applying a visual effect to a portion of a second image, corresponding to a first body portion, and a portion of the second image, corresponding to a second body portion, by a wearable electronic device according to an embodiment;

FIG. 13 is a flowchart illustrating an operation of displaying guide information to allow a second body portion to be positioned in an FOV area by a wearable electronic device according to an embodiment;

FIG. 14 is a view illustrating an operation of displaying a plurality of images by a wearable electronic device according to an embodiment;

FIG. 15A is a view illustrating an operation of displaying an image when a first posture matches a first designated exercise posture, by a wearable electronic device according to an embodiment;

FIG. 15B is a view illustrating an operation of displaying an image when a first posture does not match a first designated exercise posture, by a wearable electronic device according to an embodiment;

FIG. 16 is a view illustrating an operation of displaying feedback information based on sensing information received from a first wearable electronic device by a wearable electronic device according to an embodiment; and

FIG. 17 is a flowchart illustrating an operation of displaying a first virtual object indicating a first designated exercise posture on a first body portion positioned in an FOV area by a wearable electronic device according to an embodiment.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

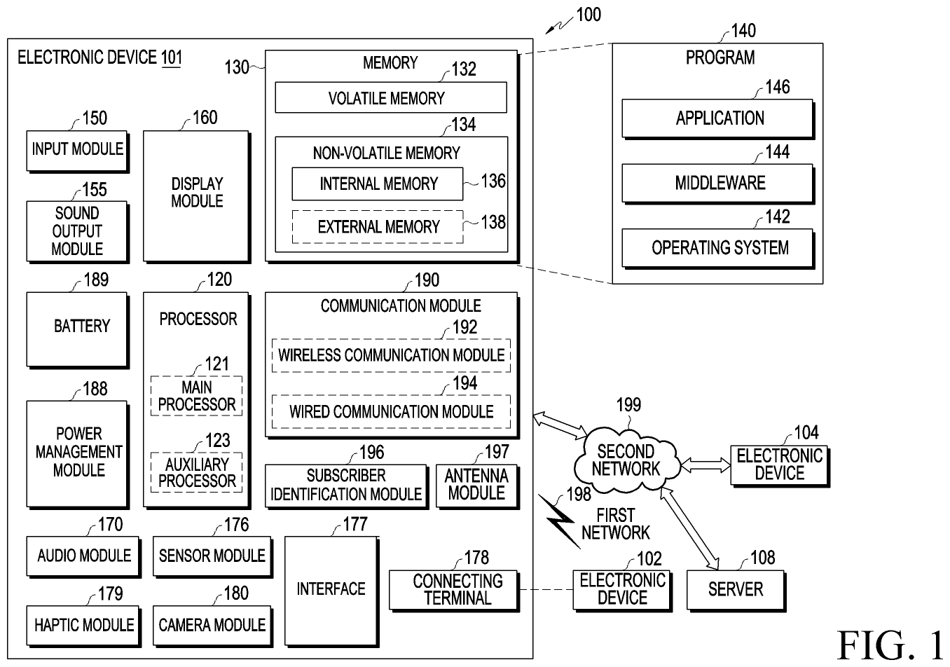

FIG. 1 is a block diagram illustrating an electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal According to an embodiment, the display module 160 may include a first display module 351 corresponding to the user's left eye and/or a second display module 353 corresponding to the user's right eye., a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

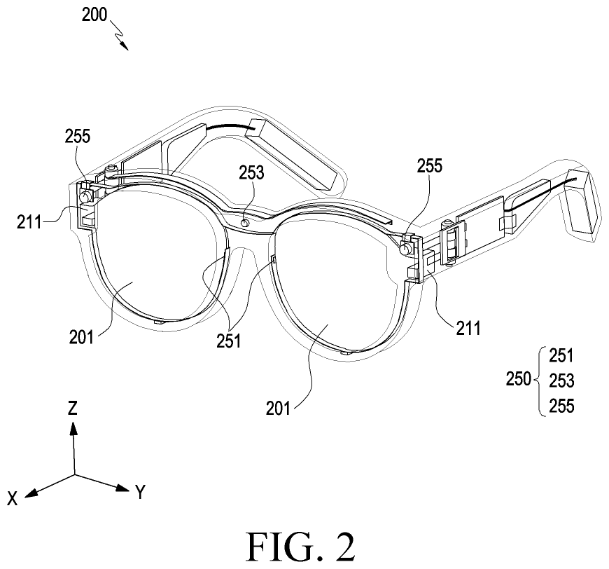

FIG. 2 is a perspective view illustrating an internal configuration of a wearable electronic device according to an embodiment of the disclosure.

Referring to FIG. 2, according to an embodiment of the disclosure, a wearable electronic device 200 may include at least one of a light output module 211, a display member 201, and a camera module 250.

According to an embodiment of the disclosure, the light output module 211 may include a light source capable of outputting an image and a lens guiding the image to the display member 201. According to an embodiment of the disclosure, the light output module 211 may include at least one of a liquid crystal display (LCD), a digital mirror device (DMD), a liquid crystal on silicon (LCoS), an organic light emitting diode (OLED), or a micro light emitting diode (micro LED).

According to an embodiment of the disclosure, the display member 201 may include an optical waveguide (e.g., a waveguide). According to an embodiment of the disclosure, the image output from the light output module 211 incident on one end of the optical waveguide may propagate inside the optical waveguide and be provided to the user. According to an embodiment of the disclosure, the optical waveguide may include at least one of at least one diffractive element (e.g., a diffractive optical element (DOE) or a holographic optical element (HOE)) or a reflective element (e.g., a reflective mirror). For example, the optical waveguide may guide the image output from the light output module 211 to the user's eyes using at least one diffractive element or reflective element.

According to an embodiment of the disclosure, the camera module 250 may capture still images and/or moving images. According to an embodiment, the camera module 250 may be disposed in a lens frame and may be disposed around the display member 201.

According to an embodiment of the disclosure, a first camera module 251 may capture and/or recognize the trajectory of the user's eye (e.g., pupil or iris) or gaze. According to an embodiment of the disclosure, the first camera module 251 may periodically or aperiodically transmit information related to the trajectory of the user's eye or gaze (e.g., trajectory information) to a processor (e.g., the processor 120 of FIG. 1).

According to an embodiment of the disclosure, a second camera module 253 may capture an external image.

According to an embodiment of the disclosure, a third camera module 255 may be used for hand detection and tracking, and recognition of the user's gesture (e.g., hand motion). According to an embodiment of the disclosure, the third camera module 255 may be used for 3 degrees of freedom (3DoF) or 6DoF head tracking, location (space, environment) recognition and/or movement recognition. The second camera module 253 may also be used for hand detection and tracking and recognition of the user's gesture. According to an embodiment of the disclosure, at least one of the first camera module 251 to the third camera module 255 may be replaced with a sensor module (e.g., a LiDAR sensor). For example, the sensor module may include at least one of a vertical cavity surface emitting laser (VCSEL), an infrared sensor, and/or a photodiode.

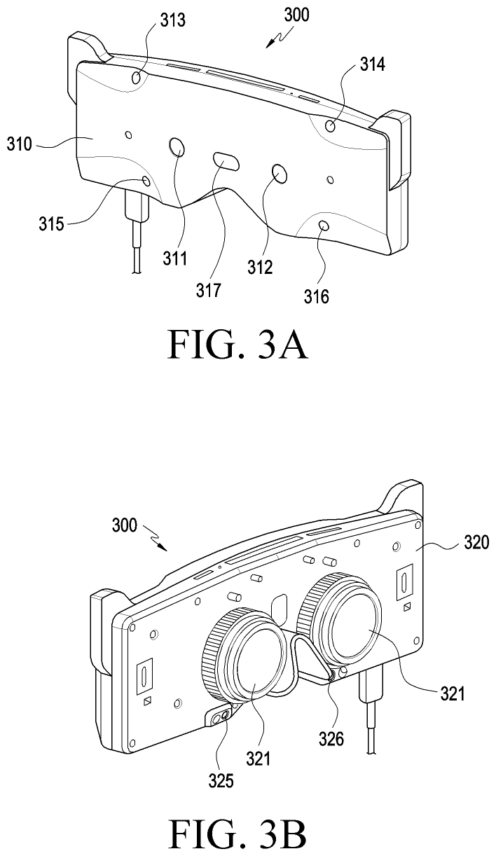

FIGS. 3A and 3B are views illustrating front and rear surfaces of a wearable electronic device according to an embodiment;

Referring to FIGS. 3A and 3B, in an embodiment, camera modules 311, 312, 313, 314, 315, and 316 and/or a depth sensor 317 for obtaining information related to the ambient environment of the wearable electronic device 300 may be disposed on the first surface 310 of the housing.

In an embodiment, the camera modules 311 and 312 may obtain images related to the ambient environment of the wearable electronic device.

In an embodiment, the camera modules 313, 314, 315, and 316 may obtain images while the wearable electronic device is worn by the user. The camera modules 313, 314, 315, and 316 may be used for hand detection, tracking, and recognition of the user gesture (e.g., hand motion). The camera modules 313, 314, 315, and 316 may be used for 3DoF or 6DoF head tracking, location (space or environment) recognition, and/or movement recognition. In an embodiment, the camera modules 311 and 312 may be used for hand detection and tracking and recognition of the user's gesture.

In an embodiment, the depth sensor 317 may be configured to transmit a signal and receive a signal reflected from an object and be used for identifying the distance to the object, such as time of flight (TOF). Alternatively or additionally to the depth sensor 217, the camera modules 213, 214, 215, and 216 may identify the distance to the object.

According to an embodiment, camera modules 325 and 326 for face recognition and/or a display 321 (and/or lens) may be disposed on the second surface 320 of the housing.

In an embodiment, the face recognition camera modules 325 and 326 adjacent to the display may be used for recognizing the user's face or may recognize and/or track both eyes of the user.

In an embodiment, the display 321 (and/or lens) may be disposed on the second surface 320 of the wearable electronic device 300. In an embodiment, the wearable electronic device 300 may not include the camera modules 315 and 316 among the plurality of camera modules 313, 314, 315, and 316. Although not shown in FIGS. 3A and 3B, the wearable electronic device 300 may further include at least one of the components shown in FIG. 2.

As described above, according to an embodiment, the wearable electronic device 300 may have a form factor to be worn on the user's head. The wearable electronic device 300 may further include a strap and/or a wearing member to be fixed on the user's body part. The wearable electronic device 300 may provide the user experience based on augmented reality, virtual reality, and/or mixed reality while worn on the user's head.

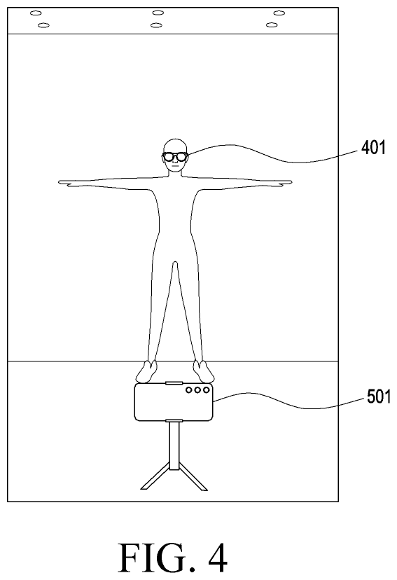

FIG. 4 is a view illustrating a system including a wearable electronic device and an external electronic device according to an embodiment.

Referring to FIG. 4, according to an embodiment, the wearable electronic device 401 may be implemented as AR glasses or a VST device. According to an embodiment, the wearable electronic device 401 may also be implemented as VR glasses. According to an embodiment, the external electronic device 501 may also be implemented as a smartphone. However, this is an example, and embodiments of the disclosure may be implemented as various devices.

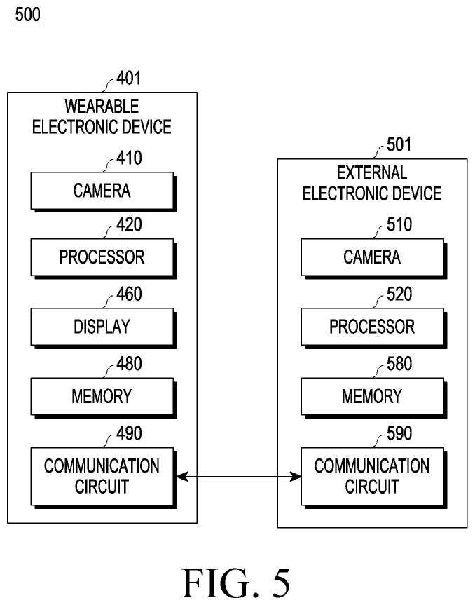

According to an embodiment, the wearable electronic device 401 may display virtual objects indicating designated exercise postures for body portions of the user wearing the wearable electronic device 401. For example, the virtual objects may be displayed on portions corresponding to the user's body portions in an image in which the FOV area of the camera 410 (e.g., the camera 410 of FIG. 5) is captured by the wearable electronic device 401. For example, virtual objects may be displayed on the body portion displayed on the FOV area of the user. For example, virtual objects may be displayed on portions corresponding to the user's body portions positioned in the FOV area of the camera 410. For example, virtual objects may be displayed on portions corresponding to the user's body portions in the image captured by the external electronic device 501. According to an embodiment, the FOV area of the camera 410 may include an area corresponding to the viewing angle of the camera 410. According to an embodiment, the FOV area of the user may include an actual area displayed through the glass (e.g., the display member 201 of FIG. 2) of the AR glasses or the display (e.g., the display 321 of FIG. 3B) of the VST device.

According to an embodiment, the wearable electronic device 401 may superimpose and display virtual objects corresponding to the body portions on the portions corresponding to the user's body portions.

According to an embodiment, the wearable electronic device 401 may identify whether postures of the user's body portions match designated exercise postures, and may display feedback information using the virtual objects. For example, the wearable electronic device 401 may provide a moving direction of a designated exercise posture in a 3D exercise. For example, the wearable electronic device 401 may apply a visual effect to the virtual object so that the virtual object is visually identified.

Accordingly, the wearable electronic device 401 according to an embodiment may provide feedback information related to the posture of the user's body portion positioned in the FOV area of the user or the FOV area of the camera in real time. The wearable electronic device 401 according to an embodiment may provide feedback information related to the posture of the user's body portion positioned in an area other than the user's FOV area or an area other than the camera's FOV area in real time.

FIG. 5 is a block diagram schematically illustrating a system 500 including a wearable electronic device and an external electronic device according to an embodiment.

Referring to FIG. 5, according to an embodiment, a wearable electronic device 401 may include a camera 410, a processor 420, a display 460, memory 480, and communication circuitry 490. According to an embodiment, the wearable electronic device 401 may be implemented with augmented reality (AR) glasses or a video see through (VST) device. According to an embodiment, the wearable electronic device 401 may be implemented to be the same as or similar to the wearable electronic device 200 of FIG. 2 or the wearable electronic device 300 of FIGS. 3A and 3B.

According to an embodiment, the processor 420 may control the overall operation of the wearable electronic device 401. For example, the processor 420 may be implemented to be identical or similar to the processor 120 of FIG. 1.

According to an embodiment, the external electronic device 501 may include a camera 510, a processor 520, memory 580, and a communication circuit 590. According to an embodiment, the external electronic device 501 may be implemented as a smartphone or a tablet PC. According to an embodiment, the processor 520 may control the overall operation of the external electronic device 501. For example, the processor 520 may be implemented to be identical or similar to the processor 120 of FIG. 1.

According to an embodiment, the processor 520 may transmit, to the wearable electronic device 401, a control signal for outputting information for allowing the user wearing the wearable electronic device 401 to take a specific posture. According to an embodiment, the processor 420 may output information for allowing the user wearing the wearable electronic device 401 to take a specific posture. For example, the processor 420 may output information for allowing the user to stand with both arms open. According to an embodiment, the information may be provided through a visual means or an auditory means. According to an embodiment, the processor 420 may display a virtual object indicating a standing posture with both arms open.

According to an embodiment, the processor 520 may identify a first distance between the wearable electronic device 401 and the external electronic device 501 using a sensor (not shown) of the external electronic device 501. According to an embodiment, the processor 420 may identify the first distance between the wearable electronic device 401 and the external electronic device 501 using the sensor (not shown) of the wearable electronic device 401. According to an embodiment, when it is identified that the first distance is smaller than a designated distance or is identified that the first distance is larger than the designated distance, the processor 420 may output feedback information for adjusting the distance. For example, the designated distance may mean a distance by which the external electronic device 501 is spaced apart to capture an image including the user's body portions. The feedback information may be provided through a visual means or an auditory means.

According to an embodiment, the processor 520 may identify whether the user's body portions are included in the images obtained using the camera 510. According to an embodiment, the processor 420 may not transmit the images not including the user's body portions to the wearable electronic device 401 but transmit only images including the user's body portions to the wearable electronic device 401. According to an embodiment, the processor 520 may identify whether the images obtained from the external electronic device 501 include the user's body portions.

According to an embodiment, the processor 520 may obtain the first image using the camera 510. According to an embodiment, the first image may include an image in which the body portions of the user wearing the wearable electronic device 401 are captured. According to an embodiment, when it is identified to output information for allowing the user wearing the wearable electronic device 401 to take a specific posture, the processor 520 may obtain the first image using the camera 510.

According to an embodiment, the processor 520 may obtain information about the body portions using the first image. For example, the information about the body portions may include information about the height of the user or information about the length of each of the body portions. For example, the information about the body portions may include information about the location (e.g., coordinates) of each of the user's body portions. According to the implementation, the processor 420 may obtain information about body portions using the first image.

According to an embodiment, the processor 420 may identify information about the user's body portions previously stored in the memory 480. According to an embodiment, the processor 520 may identify information about the user's body portions previously stored in the memory 580.

According to an embodiment, the processor 420 may obtain information about the user's body portions from the external electronic device 501 through the communication circuit 490. In this case, the processor 420 may obtain the first image from the external electronic device 501.

According to an embodiment, the processor 420 may obtain exercise information about designated exercise postures using the user's body portions from the external electronic device 501 through the communication circuitry 490. For example, the exercise information about the designated exercise postures may be information stored in the memory 580. For example, designated exercise postures may include dynamic exercise postures and/or static exercise postures. For example, the designated exercise postures may include designated postures sequentially performed. For example, the body portions may include the user's neck, arms, hands, upper body, pelvis, thighs, shins, feet, waist, calf, hips, or lower body. According to the implementation, the processor 420 may obtain exercise information about designated exercise postures from a separate server. According to an embodiment, the information about the designated exercise postures may be previously stored in the memory 480.

According to an embodiment, the processor 420 may display the first image through the display 460. According to an embodiment, the processor 420 may display virtual objects indicating designated exercise postures related to the body portions on the portions corresponding to the body portions included in the first image. According to an embodiment, the virtual objects may be virtual objects based on information about the user's body portions. According to an embodiment, after displaying the first image, the processor 420 may display the virtual objects on portions corresponding to body portions included in the first image. According to an embodiment, the processor 420 may simultaneously perform the operation of displaying the first image and the operation of displaying virtual objects indicating the designated exercise postures on portions corresponding to body portions included in the first image. Accordingly, the processor 420 may provide information about designated exercise postures corresponding to the user's body portions positioned in the FOV area and the area other than the FOV area of the camera 410.

According to an embodiment, the processor 420 may identify whether a rendering delay occurs when virtual objects are displayed on portions corresponding to body portions included in the first image. According to an embodiment, when it is identified that the rendering delay occurs, the processor 420 may not display the virtual objects on the portions corresponding to the body portions included in the first image. According to an embodiment, when it is identified that the moving speed of the first body portion is larger than the designated moving speed, the processor 420 may identify that a rendering delay occurs. According to an embodiment, when it is identified that the moving speed of the first body portion is larger than the designated moving speed, based on the history information about the posture of the first body portion of the user previously stored in the memory 480, the processor 420 may identify that a rendering delay occurs.

According to an embodiment, the processor 420 may display a virtual object indicating the first designated exercise posture on a portion corresponding to the first body portion included in the first image. According to an embodiment, the processor 420 may display a virtual object indicating a second designated exercise posture related to the second body portion on a portion corresponding to the second body portion included in the first image.

According to an embodiment, the processor 520 may obtain images using the camera 510 every preset period, and may transmit the images to the wearable electronic device 401. According to an embodiment, based on obtaining a new image from the external electronic device 501, the processor 420 may discard the image obtained immediately before, and may update and display the new image. According to an embodiment, the processor 420 may display virtual objects indicating designated exercise postures on portions corresponding to the user's body portions included in the new image. According to an embodiment, the processor 520 may obtain a video using the camera 510 every preset period.

According to an embodiment, the processor 520 may obtain a second image after the first image through the camera 510. According to an embodiment, the second image may include an image obtained while the user is performing the first posture of the first body portion. According to an embodiment, the second image may include an image obtained while the user is performing the second posture of the second body portion. According to an embodiment, the processor 420 may display a second image. According to an embodiment, the processor 420 may display a virtual object indicating the first designated exercise posture on a portion corresponding to the first body portion included in the second image, and may display a virtual object indicating the second designated exercise posture on a portion corresponding to the second body portion. According to an embodiment, the processor 420 may identify whether at least one body portion among the user's body portions is positioned in the FOV area of the camera 410. According to an embodiment, when at least one of the user's body portions is positioned in the FOV area of the camera 410, the at least one body portion may be identified through the display 460. According to an embodiment, when at least one of the user's body portions is not positioned in the FOV area of the camera 410, the at least one body portion may not be identified through the display 460.

According to an embodiment, when it is identified that the first body portion of the user is positioned in the field of view (FOV) area of the camera 410, the processor 420 may superimpose and display the first virtual object indicating the first designated exercise posture related to the first body portion among the designated exercise postures on the portion corresponding to the first body portion identified through the display 460. According to an embodiment, the first virtual objects may be virtual objects based on information about the user's body portions. For example, the length of the first virtual object may correspond to the length of the first body portion. For example, the area of the first virtual object may correspond to the area of the first body portion. For example, the shape of the first virtual object may correspond to the shape of the first body portion. According to an embodiment, the processor 420 may identify whether at least one of the user's body portions is positioned in the FOV area of the camera 410 using the first image. For example, the processor 420 may obtain an image in real time (or periodically) through the camera 410. The processor 420 may identify whether the first body portion of the user is positioned in the FOV area of the camera 410 using the image obtained in real time (or periodically obtained image) and the first image. According to an embodiment, the FOV area of the camera 410 may indicate an area corresponding to the viewing angle of the camera 410.

According to an embodiment, the processor 420 may identify whether the first designated exercise posture matches the first posture of the first body portion. According to an embodiment, the processor 420 may identify whether the first designated exercise posture matches the first posture, based on at least one of the position of the first body portion, the moving direction of the first body portion, or the moving speed of the first body portion identified through the display 460. According to an embodiment, the processor 420 may identify a first matching degree between the first designated exercise posture and the first posture. According to an embodiment, when it is identified that the first matching degree is larger than a first designated value, the processor 420 may identify that the first designated exercise posture matches the first posture. For example, the first matching degree may be obtained as a number of 0 to 100. For example, the first designated value may mean a value at which the first designated motion posture matches the first posture.

According to an embodiment, the processor 420 may compare the position of the first body portion identified through the display 460 or the position where the first body portion is displayed in the second image with the position where the first designated exercise posture is displayed. For example, the processor 420 may identify a first ratio in which the area corresponding to the first body portion identified through the display 460 occupies in the area corresponding to the position where the first designated exercise posture is displayed. According to an embodiment, the processor 420 may identify that the greater the first ratio, the greater the first matching degree. For example, when the first ratio is 10%, the processor 420 may identify the first matching degree as 10%. For example, when the first ratio is 100%, the wearable electronic device 401 may identify the first matching degree as 100%.

According to an embodiment, the processor 420 may compare the moving direction of the first body portion with the moving direction of the first designated exercise posture. According to an embodiment, when the moving direction of the first body portion is different from the moving direction of the first designated exercise posture, the processor 420 may identify that the first matching degree between the first posture and the first designated exercise posture is 0%. According to an embodiment, when the moving direction of the first body portion is the same as the moving direction of the first designated exercise posture, the processor 420 may identify that the first matching degree between the first posture and the first designated exercise posture is 100%.

According to an embodiment, the processor 420 may compare the moving speed of the first body portion with the moving speed of the first designated exercise posture. According to an embodiment, the processor 420 may identify the moving speed of the first body portion using a sensor (not shown) included in the wearable electronic device. According to an embodiment, the processor 420 may identify the moving speed of the first body portion obtained using a sensor (not shown) included in the external electronic device 501. According to an embodiment, the processor 420 may identify a second ratio between the moving speed of the first body portion and the moving speed of the first designated exercise posture. According to an embodiment, the processor 420 may identify that the greater the second ratio, the greater the first matching degree. For example, when the second ratio is 10%, the processor 420 may identify the first matching degree as 10%. For example, when the second ratio is 100%, the processor 420 may identify the first matching degree as 100%.

According to an embodiment, the processor 420 may identify the average of the sum of the first ratio (e.g., 0 to 100), the second ratio (e.g., 0 to 100), and the matching degree (e.g., 0 or 100) between the moving direction of the first body portion and the moving direction of the first designated exercise posture as the first matching degree. According to an embodiment, the processor 420 may identify depth information about the second image. According to an embodiment, when the processor 420 is unable to obtain the depth value corresponding to the portion corresponding to the first body portion included in the second image, the processor 420 may not identify the first matching degree.

According to an embodiment, the processor 420 may display feedback information for correcting the first posture using the first virtual object, based on identifying that the first designated exercise posture does not match the first posture. According to an embodiment, the processor 420 may apply a visual effect to the first virtual object so that the first virtual object is visually identified. According to an embodiment, the processor 420 may adjust the color, transparency, or size of the first virtual object. According to an embodiment, the processor 420 may display information about the moving direction so that the first body portion moves to the position where the first virtual object is displayed. For example, the processor 420 may output information about the moving direction through an auditory means so that the first body portion moves to the position where the first virtual object is displayed. According to an embodiment, the processor 420 may provide feedback information through a tactile means. For example, the processor 420 may output a vibration until the first designated exercise posture matches the first posture, based on identifying that the first designated exercise posture does not match the first posture. According to an embodiment, the processor 420 may adjust the intensity of the sound or the intensity of the vibration to be greater as the first matching degree decreases. According to an embodiment, the processor 420 may adjust the period in which the sound or vibration is output to be shorter as the first matching degree decreases.

According to an embodiment, the processor 420 may adjust the moving speed of the first designated posture, based on identifying that the first designated exercise posture does not match the first posture. According to an embodiment, the processor 420 may adjust the moving speed of the first designated posture to decrease. According to an embodiment, the processor 420 may display a designated posture related to a first body portion after the first designated posture having a difficulty level lower than that of the first designated posture, based on identifying that the first designated exercise posture does not match the first posture. According to an embodiment, the processor 420 may increase the size of the first virtual object indicating the first designated posture, based on identifying that the first designated exercise posture does not match the first posture. According to an embodiment, when it is identified that the first designated exercise posture does not match the first posture for a preset time or a preset number of times or more, the processor 420 may display feedback information to repeatedly perform the first designated exercise posture without displaying the designated exercise posture after the first designated exercise posture related to the first body portion. For example, the processor 420 may display a designated exercise posture after the first designated exercise posture related to the first body portion at a time when it is identified that the number of times the first body portion matches the first designated exercise posture is a designated number of times.

According to an embodiment, the processor 420 may display feedback information indicating that the first posture matches the first designated exercise posture using the first virtual object, based on identifying that the first designated exercise posture matches the first posture. According to an embodiment, the processor 420 may apply a visual effect to the first virtual object so that the first virtual object is visually identified, based on identifying that the first designated exercise posture matches the first posture. According to an embodiment, the processor 420 may adjust the color, transparency, or size of the first virtual object. For example, the processor 420 may output information indicating that the first designated exercise posture matches the first posture through an auditory means.

According to an embodiment, based on identifying that the first designated exercise posture matches the first posture, the processor 420 may display a third virtual object indicating a third designated exercise posture after the first designated exercise posture on the first body portion identified through the display 460. For example, the third designated exercise posture may include a designated exercise posture related to the first body portion. According to an embodiment, the processor 520 may obtain a third image after the second image through the camera 510. According to an embodiment, the third image may be an image including the user's first body portion. According to an embodiment, the processor 420 may display a third virtual object indicating the third designated exercise posture after the first designated exercise posture related to the first body portion on the portion corresponding to the first body portion included in the third image.

According to an embodiment, the processor 420 may identify whether the second posture of the second body portion of the user positioned in an area other than the FOV area of the camera 410 matches the second designated exercise posture related to the second body portion. According to an embodiment, the processor 420 may identify whether the second designated exercise posture matches the second posture, based on at least one of the position where the second body portion is displayed in the second image, the moving direction of the second body portion, or the moving speed of the second body portion. According to an embodiment, the processor 420 may identify a second matching degree between the second designated exercise posture and the second posture. According to an embodiment, when it is identified that the second matching degree is larger than the second designated value, the processor 420 may identify that the second designated exercise posture matches the second posture. For example, the second matching degree may be obtained as a number of 0 to 100. For example, the second designated value may mean a value at which the second posture matches the second designated exercise posture.

According to an embodiment, the processor 420 may compare the position where the second body portion is displayed in the second image with the position where the second designated exercise posture is displayed. For example, the processor 420 may identify a third ratio in which the area corresponding to the position where the second body portion is displayed occupies in the area corresponding to the position where the second designated exercise posture is displayed. According to an embodiment, the processor 420 may identify that the greater the third ratio, the greater the second matching degree. For example, when the third ratio is 10%, the processor 420 may identify the second matching degree as 10%. For example, when the third ratio is 100%, the processor 420 may identify the second matching degree as 100%.

According to an embodiment, the processor 420 may compare the moving direction of the second body portion with the moving direction of the second designated exercise posture. According to an embodiment, when the moving direction of the second body portion is different from the moving direction of the second designated exercise posture, the processor 420 may identify that the second matching degree between the second posture and the second designated exercise posture is 0%. According to an embodiment, when the moving direction of the second body portion is the same as the moving direction of the second designated exercise posture, the processor 420 may identify that the first matching degree between the second posture and the first designated exercise posture is 100%.

According to an embodiment, the processor 420 may compare the moving speed of the second body portion with the moving speed of the second designated exercise posture. According to an embodiment, the processor 420 may identify a fourth ratio between the moving speed of the second body portion and the moving speed of the second designated exercise posture. According to an embodiment, the processor 420 may identify that the greater the fourth ratio, the greater the second matching degree. For example, when the fourth ratio is 10%, the processor 420 may identify the second matching degree as 10%. For example, when the fourth ratio is 100%, the processor 420 may identify the second matching degree as 100%.

According to an embodiment, the processor 420 may identify the average of the sum of the third ratio (e.g., 0 to 100), the fourth ratio (e.g., 0 to 100), and the matching degree (e.g., 0 or 100) between the moving direction of the second body portion and the moving direction of the second designated exercise posture as the second matching degree. According to an embodiment, when the processor 420 is unable to obtain the depth value corresponding to the portion corresponding to the second body portion included in the second image, the processor 420 may not identify the second matching degree.

According to an embodiment, when it is identified that the second posture does not match the second designated exercise posture, the processor 420 may display guide information to allow the second body portion to be positioned in the FOV area of the camera 410. According to an embodiment, the processor 420 may display information about the direction in which the second body portion is positioned with respect to the center of the FOV area of the camera 410. For example, the processor 420 may output information about the direction in which the second body portion is positioned through an auditory means. According to an embodiment, the processor 420 may provide feedback information through a tactile means. For example, the processor 420 may output vibration in the direction in which the second body portion is positioned.

According to an embodiment, the first posture of the first body portion and the posture of the second body portion may be postures performed simultaneously. According to an embodiment, when it is identified that the first posture of the first body portion positioned in the FOV area of the camera 410 matches the first designated posture, the processor 420 may display guide information to allow the second body portion to be positioned in the FOV area.

According to an embodiment, the processor 420 may adjust the moving speed of the second designated posture to decrease, based on identifying that the second posture does not match the second designated exercise posture. According to an embodiment, based on identifying that the second posture does not match the second designated exercise posture, the processor 420 may display a designated posture after the second designated posture having a difficulty level lower than that of the second designated posture.

According to an embodiment, when it is identified that the second body portion is positioned in the FOV area of the camera 410, the processor 420 may display the second virtual object indicating the second designated exercise posture on the second body portion. According to an embodiment, the processor 420 may identify whether the second posture matches the second designated exercise posture.

According to an embodiment, based on identifying that the second designated exercise posture does not match the second posture of the second body, the processor 420 may display feedback information indicating that the second posture does not match the second designated posture using the second virtual object. According to an embodiment, the processor 420 may apply a visual effect to the second virtual object so that the second virtual object is visually identified. According to an embodiment, the processor 420 may adjust the color, transparency, or size of the second virtual object. According to an embodiment, the processor 420 may display information about the moving direction so that the second body portion moves to the position where the second virtual object is displayed. For example, the processor 420 may output information about the moving direction through an auditory means so that the second body portion moves to the position where the second virtual object is displayed. According to an embodiment, the processor 420 may provide feedback information through a tactile means. For example, the processor 420 may output a vibration until the second designated exercise posture matches the second posture, based on identifying that the second designated exercise posture does not match the second posture. According to an embodiment, the processor 420 may adjust the output intensity of the sound or vibration to be greater as the second matching degree decreases. According to an embodiment, the processor 420 may adjust the period in which the sound or vibration is output to be shorter as the second matching degree decreases.

According to an embodiment, when the second designated exercise posture matches the second posture of the second body portion and the second body portion is positioned in the FOV area of the camera 410, the processor 420 may display a virtual object indicating a fourth designated exercise posture after the second designated exercise posture on a portion corresponding to the second body portion identified through the display 460. According to an embodiment, when the third image after the second image is obtained, the processor 420 may discard the image obtained immediately before and display the third image. According to an embodiment, the processor 420 may display a fourth virtual object indicating a fourth designated exercise posture after the second designated exercise posture on a portion corresponding to the second body portion included in the third image. For example, the fourth designated exercise posture may include a designated exercise posture related to the second body portion. According to an embodiment, when the second designated exercise posture matches the second posture of the second body portion, the processor 420 may display a fourth virtual object indicating a fourth designated exercise posture after the second designated exercise posture on a portion corresponding to the second body portion in the third image after the second image.

According to an embodiment, the processor 420 may apply a visual effect to the virtual object indicating the first designated exercise posture or the virtual object indicating the second designated exercise posture included in the second image. According to an embodiment, the processor 420 may apply a visual effect to a portion corresponding to the first body portion or a portion corresponding to the second body portion included in the second image. According to an embodiment, when it is identified that the first posture does not match the first designated exercise posture, the processor 420 may apply a visual effect to the virtual object indicating the first designated exercise posture included in the second image. According to an embodiment, when it is identified that the second posture does not match the second designated exercise posture, the processor 420 may apply a visual effect to the virtual object indicating the second designated exercise posture included in the second image.

According to an embodiment, the processor 420 may compare the first matching degree with the second matching degree, and may apply a visual effect to the second image based on the comparison result. According to an embodiment, when it is identified that the first matching degree is lower than the second matching degree, the processor 420 may apply a visual effect to a portion corresponding to the first body portion included in the second image. According to an embodiment, the wearable electronic device 401 may simultaneously apply a visual effect to a portion corresponding to the first body portion and a portion corresponding to the second body portion included in the second image.

According to an embodiment, the processor 420 may display a plurality of second images. According to an embodiment, the processor 420 may display the second image in which the visual effect is applied to the portion corresponding to the first body portion at the first position. According to an embodiment, the processor 420 may display the second image in which the visual effect is applied to the portion corresponding to the second body portion at the second position. For example, the first position may be different from the second position. For example, the first position and the second position may include an upper area of the FOV area of the user. However, this is an example, and the first position and the second position may not be limited thereto.

According to an embodiment, the processor 420 may determine the first position and the second position based on a result of comparing the first matching degree and the second matching degree. According to an embodiment, the processor 420 may adjust the first size of the second image in which the visual effect is applied to the portion corresponding to the first body portion and the second size of the second image in which the visual effect is applied to the portion corresponding to the second body portion, based on the comparison result between the first matching degree and the second matching degree. According to an embodiment, when it is identified that the first matching degree is smaller than the second matching degree, the processor 420 may be positioned relatively higher or more left than the second position. According to an embodiment, when it is identified that the first matching degree is smaller than the second matching degree, the processor 420 may adjust the first size to be larger than the second size.

According to an embodiment, when it is identified that the first posture matches the first designated posture, the processor 420 may not display the second image in which the visual effect is applied to the portion corresponding to the first body portion.

According to an embodiment, the processor 420 may apply the visual effect to the portion corresponding to the second body portion included in the second image, a designated time after applying the visual effect to the portion corresponding to the first body portion included in the second image.

According to an embodiment, the processor 520 may obtain an image including at least one of the user's body portions through the camera 510. According to an embodiment, the processor 520 may compare the posture of the at least one body portion of the user with the at least one exercise posture related to the at least one body portion, based on the obtained image. According to an embodiment, the processor 520 may transmit feedback information to the wearable electronic device 401 based on the comparison result.

According to an embodiment, operations performed by the wearable electronic device 401 may be performed by the external electronic device 501. According to an embodiment, descriptions related to the wearable electronic device 401 may be equally applied to the external electronic device 501.

Operations of the wearable electronic device 401 described below may be performed by the processor 420. However, for convenience of description, it is described that the operations performed by the processor 420 are performed by the wearable electronic device 401. Operations of the external electronic device 501 described below may be performed by the processor 520. However, for convenience of description, it is described that the operations performed by the processor 520 are performed by the external electronic device 501.

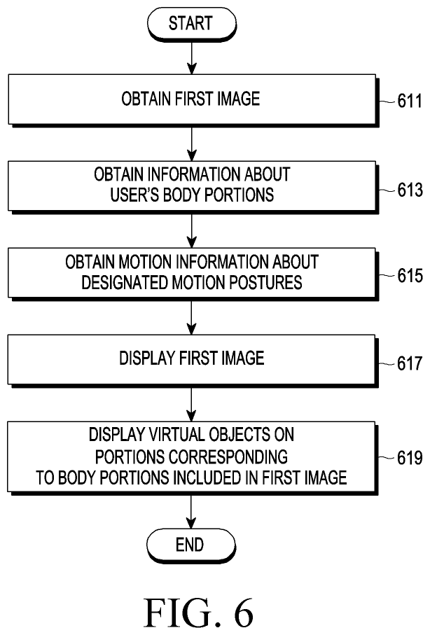

FIG. 6 is a flowchart illustrating an operation of displaying a first image by a wearable electronic device according to an embodiment of the disclosure.

Referring to FIG. 6, according to an embodiment, in operation 611, a wearable electronic device 401 (e.g., the wearable electronic device 401 of FIG. 5) may obtain a first image from an external electronic device 501 (e.g., the external electronic device 501 of FIG. 5). According to an embodiment, the external electronic device 501 may obtain a first image using a camera 510 (e.g., the camera 510 of FIG. 5). According to an embodiment, the first image may include an image in which the body portions of the user wearing the wearable electronic device 401 are captured. According to an embodiment, the external electronic device 501 may obtain information about the body portions using the first image. For example, the information about the body portions may include information about the height of the user or information about the length of each of the body portions.

According to an embodiment, in operation 613, the wearable electronic device 401 may obtain information about the user's body portions from the external electronic device 501. According to an embodiment, the wearable electronic device 401 may obtain information about body portions of the user by the user. According to an embodiment, the wearable electronic device 401 may obtain information about the user's body portions using the first image. However, this is merely an example, and embodiments of the disclosure may obtain information about the user's body portions in various ways.

According to an embodiment, in operation 615, the wearable electronic device 401 may obtain exercise information about designated exercise postures using body portions from the external electronic device 501. For example, designated exercise postures may include dynamic exercise postures and/or static exercise postures. For example, the designated exercise postures may include exercise postures sequentially performed.

According to an embodiment, in operation 617, the wearable electronic device 401 may display a first image.

According to an embodiment, in operation 619, the wearable electronic device 401 may display virtual objects indicating designated exercise postures on portions corresponding to body portions included in the first image. Accordingly, the wearable electronic device 401 may provide information about designated exercise postures corresponding to the user's body portions positioned in an area other than the FOV area of the camera 410. According to an embodiment, the wearable electronic device 401 may simultaneously perform the operation of displaying the first image and the operation of displaying virtual objects indicating the designated exercise postures on portions corresponding to body portions included in the first image.

According to an embodiment, the external electronic device 501 may obtain images using the camera 510 every preset period, and may transmit the images to the wearable electronic device 401. According to an embodiment, the wearable electronic device 401 may discard the first image obtained immediately before from the external electronic device 501, and may update and display the second image after the first image. According to an embodiment, the wearable electronic device 401 may display virtual objects indicating designated exercise postures on portions corresponding to body portions included in the second image.

According to an embodiment, in an embodiment of the disclosure, operations 611 to 619 may be performed simultaneously.

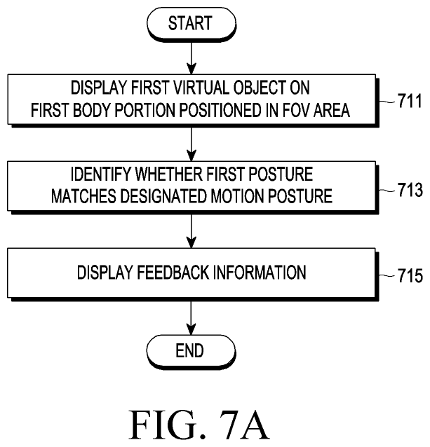

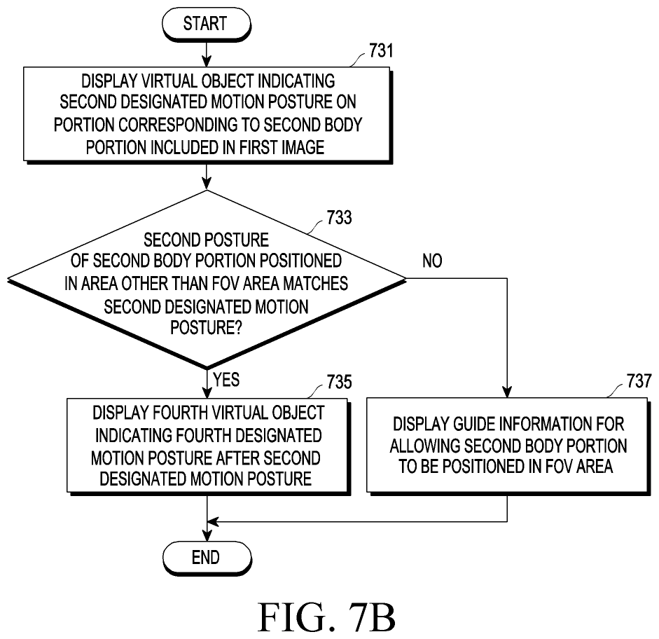

FIG. 7A is a flowchart illustrating an operation of displaying a first virtual object indicating a first designated exercise posture on a first body portion positioned in an FOV area by a wearable electronic device according to an embodiment.

Referring to FIG. 7A, according to an embodiment, in operation 711, when it is identified that the first body portion of the user is included in a field of view (FOV) area of the camera 410 (e.g., the camera 410 of FIG. 5), the wearable electronic device 401 (e.g., the wearable electronic device 401 of FIG. 5) may display, through the display 460 (e.g., the display 460 of FIG. 5), a first virtual object indicating a first designated exercise posture while overlapping the first body portion identified through the display 460. For example, the first designated exercise posture may include an exercise posture related to the first body portion. According to an embodiment, the FOV area of the camera 410 may represent the field of view of the camera 410.

According to an embodiment, the wearable electronic device 401 may display, through the display 460, a first virtual object indicating a first designated exercise posture on the first body portion of the user positioned in the FOV area of the user. For example, the FOV area of the user may mean a real environment displayed through the display 460 of the wearable electronic device 401.

According to an embodiment, in operation 713, the wearable electronic device 401 may identify whether the first posture of the first body portion matches the first designated exercise posture. According to an embodiment, the wearable electronic device 401 may identify whether the first designated exercise posture matches the first posture, based on at least one of the position of the first body portion, the moving direction of the first body portion, or the moving speed of the first body portion identified through the display 460.

According to an embodiment, the wearable electronic device 401 may identify a first matching degree between the first designated exercise posture and the first posture. According to an embodiment, when it is identified that the first matching degree is larger than a first designated value, the wearable electronic device 401 may identify that the first designated exercise posture matches the first posture. For example, the first matching degree may be obtained as a value of 0 to 100. For example, the first designated value may mean a value at which the first designated exercise posture matches the first posture. For example, the first designated value may be set automatically by the wearable electronic device 401 or by the user.

According to an embodiment, the wearable electronic device 401 may compare the position of the first body portion identified on the display 460 with the position at which the first designated exercise posture is displayed. For example, the wearable electronic device 401 may identify a first ratio in which the area corresponding to the position of the first body portion identified on the display 460 occupies in the area corresponding to the position at which the first designated exercise posture is displayed. According to an embodiment, the wearable electronic device 401 may identify that the greater the first ratio, the greater the first matching degree.

According to an embodiment, the wearable electronic device 401 may compare the moving direction of the first body portion with the moving direction of the first designated exercise posture. According to an embodiment, when the moving direction of the first body portion is different from the moving direction of the first designated exercise posture, the wearable electronic device 401 may identify that the first matching degree between the first posture and the first designated exercise posture is 0%. According to an embodiment, when the moving direction of the first body portion is the same as the moving direction of the first designated exercise posture, the wearable electronic device 401 may identify that the first matching degree between the first posture and the first designated exercise posture is 100%.

According to an embodiment, the wearable electronic device 401 may compare the moving speed of the first body portion with the moving speed of the first designated exercise posture. According to an embodiment, the wearable electronic device 401 may identify a second ratio between the moving speed of the first body portion and the moving speed of the first designated exercise posture. According to an embodiment, the wearable electronic device 401 may identify that the greater the second ratio, the greater the first matching degree.

According to an embodiment, the wearable electronic device 401 may identify the average of the sum of the first ratio (e.g., 0 to 100), the second ratio (e.g., 0 to 100), and the matching degree (e.g., 0 or 100) between the moving direction of the first body portion and the moving direction of the first designated exercise posture as the first matching degree.

According to an embodiment, in operation 715, the wearable electronic device 401 may display feedback information.

According to an embodiment, when it is identified that the first designated exercise posture does not match the first posture, the wearable electronic device 401 may display first feedback information for correcting the first posture using the first virtual object through the display 460. According to an embodiment, the wearable electronic device 401 may apply a visual effect to the first virtual object so that the first virtual object is visually identified. According to an embodiment, the wearable electronic device 401 may adjust the color, transparency, or size of the first virtual object. For example, the wearable electronic device 401 may increase the size of the first virtual object. For example, the wearable electronic device 401 may darken the color of the first virtual object. According to an embodiment, the wearable electronic device 401 may display information about the moving direction so that the first body portion moves to the position where the first virtual object is displayed. According to an embodiment, the wearable electronic device 401 may output information about the moving direction through an auditory means or a tactile means. For example, the wearable electronic device 401 may output vibration until the first designated exercise posture matches the first posture.

According to an embodiment, when it is identified that the first designated exercise posture matches the first posture, the wearable electronic device 401 may display, through the display 460, second feedback information indicating that the first posture matches the first designated exercise posture using the first virtual object. According to an embodiment, the wearable electronic device 401 may adjust the color, transparency, or size of the first virtual object. According to an embodiment, the color, transparency, or size of the first virtual object displayed when it is identified that the first designated exercise posture matches the first posture may be different from the color, transparency, or size of the first virtual object displayed when it is identified that the first designated exercise posture does not match the first posture. According to an embodiment, the wearable electronic device 401 may output information indicating that the first designated exercise posture matches the first posture through an auditory means.

FIG. 7B is a flowchart illustrating an operation of displaying a second virtual object indicating a second designated exercise posture on a second body portion positioned in an area other than an FOV area by a wearable electronic device according to an embodiment.

Referring to FIG. 7B, according to an embodiment, in operation 731, the wearable electronic device 401 (e.g., the wearable electronic device 401 of FIG. 5) may display a second virtual object indicating a second designated exercise posture on a portion corresponding to the second body portion included in the first image. Accordingly, the wearable electronic device 401 may provide information about designated exercise postures corresponding to the user's body portions positioned in an area other than the FOV area of the camera 410 (e.g., the camera 410 of FIG. 5). For example, the first image may include an image in which body portions of the user are captured by the external electronic device 501 (e.g., the external electronic device 501 of FIG. 5).

According to an embodiment, in operation 733, the wearable electronic device 401 may identify whether the second posture of the second body portion positioned in the area other than the FOV area of the camera 410 matches the second designated exercise posture.

According to an embodiment, the external electronic device 501 may obtain images using the camera 510 every preset period, and may transmit the images to the wearable electronic device 401. According to an embodiment, the wearable electronic device 401 may discard the first image obtained immediately before from the external electronic device 501, and may update and display the second image after the first image. According to an embodiment, the wearable electronic device 401 may display a virtual object indicating the second designated exercise posture on the second body portion included in the second image. For example, the second image may include an image obtained while the user is performing the second posture.

According to an embodiment, the wearable electronic device 401 may identify whether the second designated exercise posture matches the second posture, based on at least one of the position where the second body portion is displayed in the second image, the moving direction of the second body portion, or the moving speed of the second body portion. According to an embodiment, the wearable electronic device 401 may identify a second matching degree between the second designated exercise posture and the second posture.

According to an embodiment, when it is identified that the second matching degree is larger than the second designated value, the wearable electronic device 401 may identify that the second designated exercise posture matches the second posture. For example, the second matching degree may be obtained as a number of 0 to 100. For example, the second designated value may mean a value at which the second posture matches the second designated exercise posture.

According to an embodiment, the wearable electronic device 401 may compare the position where the second body portion is displayed in the second image with the position where the second designated exercise posture is displayed. For example, the processor 420 may identify a third ratio in which the area corresponding to the position where the second body portion is displayed occupies in the area corresponding to the position where the second designated exercise posture is displayed. According to an embodiment, the processor 420 may identify that the greater the third ratio, the greater the second matching degree.

According to an embodiment, the wearable electronic device 401 may compare the moving direction of the second body portion with the moving direction of the second designated exercise posture. According to an embodiment, when the moving direction of the second body portion is different from the moving direction of the second designated exercise posture, the wearable electronic device 401 may identify that the second matching degree between the second posture and the second designated exercise posture is 0%. According to an embodiment, when the moving direction of the second body portion is the same as the moving direction of the second designated exercise posture, the wearable electronic device 401 may identify that the first matching degree between the second posture and the first designated exercise posture is 100%.

According to an embodiment, the wearable electronic device 401 may compare the moving speed of the second body portion with the moving speed of the second designated exercise posture. According to an embodiment, the wearable electronic device 401 may identify a fourth ratio between the moving speed of the second body portion and the moving speed of the second designated exercise posture. According to an embodiment, the wearable electronic device 401 may identify that the greater the fourth ratio, the greater the second matching degree.

According to an embodiment, the wearable electronic device 401 may identify the average of the sum of the third ratio (e.g., 0 to 100), the fourth ratio (e.g., 0 to 100), and the matching degree (e.g., 0 or 100) between the moving direction of the second body portion and the moving direction of the second designated exercise posture as the second matching degree.

According to an embodiment, when it is identified that the second posture of the second body portion matches the second designated exercise posture (Yes in operation 733), in operation 735, the wearable electronic device 401 may display a fourth virtual object indicating a fourth designated exercise posture after the second designated exercise posture.

According to an embodiment, the external electronic device 501 may obtain a third image after the second image through the camera 510. According to an embodiment, the wearable electronic device 401 may discard the second image and display the third image. According to an embodiment, the wearable electronic device 401 may display the fourth virtual object indicating the fourth designated exercise posture on the portion corresponding to the second body portion included in the third image.

According to an embodiment, when it is identified that the second posture of the second body portion does not match the second designated exercise posture (No in operation 733), in operation 737, the wearable electronic device 401 may display guide information to allow the second body portion to be positioned in the FOV area of the camera 410. According to an embodiment, the wearable electronic device 401 may display information about the direction in which the second body portion is positioned with respect to the center of the FOV area of the camera 410. For example, the wearable electronic device 401 may output information about the direction in which the second body portion is positioned through an auditory means. According to an embodiment, the wearable electronic device 401 may provide feedback information through a tactile means. For example, the wearable electronic device 401 may output vibration in the direction in which the second body portion is positioned.

According to an embodiment, when it is identified that the second body portion is positioned in the FOV area of the camera 410, the wearable electronic device 401 may display the second virtual object indicating the second designated exercise posture on the second body portion identified through the display 460.

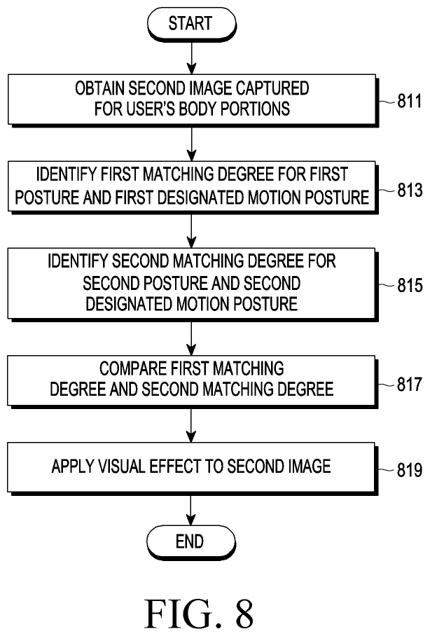

FIG. 8 is a flowchart illustrating an operation of displaying a second image to which a visual effect is applied by a wearable electronic device according to an embodiment.

Referring to FIG. 8, according to an embodiment, in operation 811, a wearable electronic device 401 (e.g., the wearable electronic device 401 of FIG. 5) may obtain a second image in which the user's body portions are captured from an external electronic device 501 (e.g., the external electronic device 501 of FIG. 5). According to an embodiment, the second image may include an image obtained by the external electronic device 501 while the user is performing the first posture of the first body portion and the second posture of the second body portion. According to an embodiment, the wearable electronic device 401 may discard the first image and may update and display the second image. For example, the first body portion may be positioned in the FOV area of the camera 410 (e.g., the camera 410 of FIG. 5), and the second body portion may be positioned in an area other than the FOV area of the camera 410. For example, the first body portion may be positioned in an area other than the FOV area of the camera 410, and the second body portion may be positioned in the FOV area of the camera 410. For example, the first body portion and the second body portion may be positioned in the FOV area of the camera 410. For example, the first body portion and the second body portion may be positioned in an area other than the FOV area of the camera 410.

According to an embodiment, in operation 813, the wearable electronic device 401 may identify a first matching degree between the first posture and the first designated exercise posture. According to an embodiment, the wearable electronic device 401 may identify the first matching degree with the first designated exercise posture, based on at least one of the position where the first body portion identified through the display 460, the moving direction of the first body portion, or the moving speed of the first body portion. Alternatively, the wearable electronic device 401 may identify the first matching degree with the first designated exercise posture based on at least one of the position where the first body portion is displayed in the second image, the moving direction of the first body portion, or the moving speed of the first body portion.

According to an embodiment, in operation 815, the wearable electronic device 401 may identify a second matching degree between the second posture and the second designated exercise posture. According to an embodiment, the wearable electronic device 401 may identify whether the second designated exercise posture matches the second posture, based on at least one of the position where the second body portion is identified through the display 460, the moving direction of the second body portion, or the moving speed of the second body portion. Or, the wearable electronic device 401 may identify whether the second designated exercise posture matches the second posture, based on at least one of the position where the second body portion is displayed in the second image, the moving direction of the second body portion, or the moving speed of the second body portion.

According to an embodiment, in operation 817, the wearable electronic device 401 may compare the first matching degree with the second matching degree.

According to an embodiment, in operation 819, the wearable electronic device 401 may apply a visual effect to the second image, based on a result of comparing the first matching degree with the second matching degree. According to an embodiment, the wearable electronic device 401 may apply a visual effect to the second image displayed through the display 460. According to an embodiment, when it is identified that the first matching degree is smaller than the second matching degree, the wearable electronic device 401 may apply a visual effect to a portion corresponding to the first body portion included in the second image. According to an embodiment, the wearable electronic device 401 may apply the visual effect to the portion corresponding to the second body portion included in the second image, a designated time after applying the visual effect to the portion corresponding to the first body portion included in the second image.

For example, the wearable electronic device 401 may apply a color different from the color of the portion corresponding to the second body portion so that the portion corresponding to the first body portion is distinguished. For example, the wearable electronic device 401 may set the transparency of the portion corresponding to the first body portion and the transparency of the portion corresponding to the second body portion to be different. However, this is merely an example, and embodiments of the disclosure may apply a visual effect to the second image in various ways.

According to an embodiment, the wearable electronic device 401 may display a plurality of second images. According to an embodiment, the wearable electronic device 401 may display the second image in which the visual effect is applied to the portion corresponding to the first body portion at the first position. According to an embodiment, the wearable electronic device 401 may display the second image in which the visual effect is applied to the portion corresponding to the second body portion at the second position. For example, the first position may be different from the second position.

According to an embodiment, when it is identified that the first matching degree is smaller than the second matching degree, the wearable electronic device 401 may be positioned relatively higher or more left than the second position. According to an embodiment, when it is identified that the first matching degree is smaller than the second matching degree, the wearable electronic device 401 may adjust the first size to be larger than the second size.

According to an embodiment, when the first posture matches the first designated posture, the wearable electronic device 401 may not display the second image in which the visual effect is applied to the portion corresponding to the first body portion.

According to an embodiment, the wearable electronic device 401 may apply the visual effect to the portion corresponding to the second body portion included in the second image, a designated time after applying the visual effect to the portion corresponding to the first body portion included in the second image.

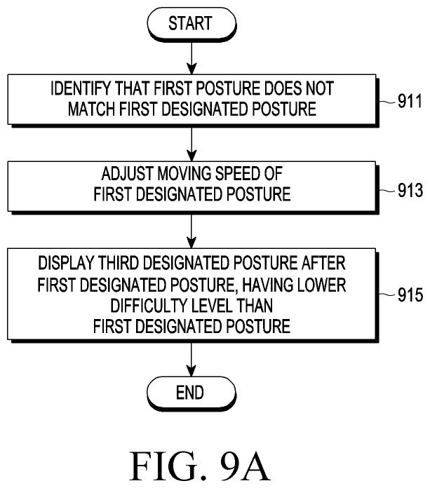

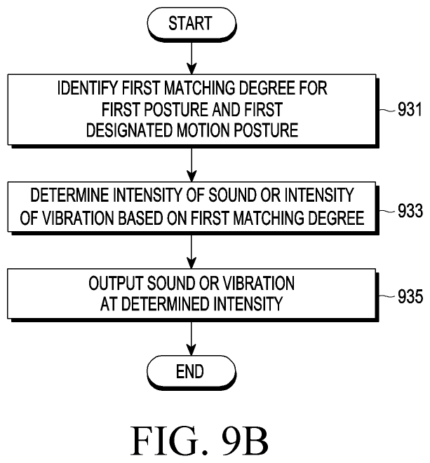

FIG. 9A is a flowchart illustrating an operation of adjusting a moving speed of a first designated posture by a wearable electronic device according to an embodiment of the disclosure.

Referring to FIG. 9A, according to an embodiment, in operation 911, the wearable electronic device 401 (e.g., the wearable electronic device 401 of FIG. 5) may identify that the first posture does not match the first designated posture, based on the first matching degree between the first posture and the first designated posture. According to an embodiment, when it is identified that the first matching degree is not larger than a first designated value, the wearable electronic device 401 may identify that the first posture does not match the first designated posture.

According to an embodiment, in operation 913, the wearable electronic device 401 may adjust the moving speed of the first designated posture based on identifying that the first posture and the first designated posture do not match each other. According to an embodiment, the wearable electronic device 401 may adjust the moving speed of the first designated posture to decrease.

According to an embodiment, in operation 915, the wearable electronic device 401 may display a third designated posture after the first designated posture having a difficulty level lower than that of the first designated posture. According to an embodiment, after it is identified that the first posture matches the first designated posture, the wearable electronic device 401 may display a third designated posture related to the first body portion after the first designated posture having a difficulty level lower than that of the first designated posture.

FIG. 9B is a flowchart illustrating an operation of outputting sound or vibration based on a first matching degree by a wearable electronic device according to an embodiment of the disclosure.

Referring to FIG. 9B, according to an embodiment, in operation 931, the wearable electronic device 401 (e.g., the wearable electronic device 401 of FIG. 5) may identify a first matching degree between the first posture and the first designated exercise posture. According to an embodiment, when it is identified that the first matching degree is smaller than the first designated value, the wearable electronic device 401 may identify that the first posture does not match the first designated exercise posture.

According to an embodiment, in operation 933, the wearable electronic device 401 may determine the intensity of the sound or the intensity of the vibration based on the first matching degree. According to an embodiment, when it is identified that the first matching degree is smaller than the first designated value, the wearable electronic device 401 may determine the intensity of the sound or the intensity of the vibration based on the first matching degree. According to an embodiment, the intensity of the sound or the intensity of the vibration may be set to be greater as the first matching degree decreases. According to an embodiment, when it is identified that the first matching degree is smaller than the first designated value, the wearable electronic device 401 may determine a period in which a sound is output or a period in which a vibration is output based on the first matching degree. According to an embodiment, the period in which the sound is output or the period in which the vibration is output may be set to be shorter as the first matching degree decreases.

According to an embodiment, in operation 935, the wearable electronic device 401 may output sound or vibration at the determined intensity. According to an embodiment, the wearable electronic device 401 may output sound or vibration at the determined period. For example, the wearable electronic device 401 may output information related to the moving direction, position, or moving speed of the first designated posture as a sound.

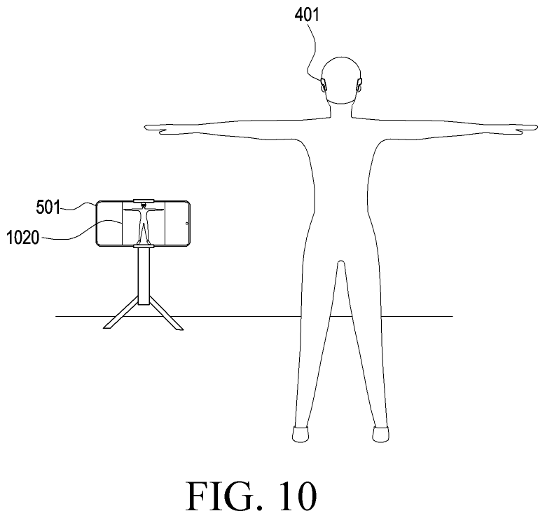

FIG. 10 is a view illustrating an operation of obtaining an image captured for body portions of a user wearing a wearable electronic device, by an external electronic device according to an embodiment.

Referring to FIG. 10, a wearable electronic device 401 (e.g., the wearable electronic device 401 of FIG. 5) may obtain a control signal for outputting information for allowing the user to take a specific posture from an external electronic device 501 (e.g., the external electronic device 501 of FIG. 5). According to an embodiment, the wearable electronic device 401 may output information for allowing the user to take a specific posture, based on the control signal. For example, the specific posture may include a posture in which the user stands with both arms open.

According to an embodiment, the wearable electronic device 401 may output information for allowing the user to take a specific posture as a sound. According to an embodiment, the wearable electronic device 401 may display a virtual object indicating a standing posture with both arms open through the display 460 (e.g., the display 460 of FIG. 5).

According to an embodiment, the external electronic device 501 may obtain an image 1020 in which the user's body portions are captured using the camera 510 (e.g., the camera 510 of FIG. 5). According to an embodiment, the external electronic device 501 may identify information about the user's body portions using the image 1020. For example, the information about the body portions may include information about the height of the user or the lengths of the body portions.

According to an embodiment, the wearable electronic device 401 may obtain the first image 1020 from the external electronic device 501. In this case, the wearable electronic device 401 may obtain information about body portions together.

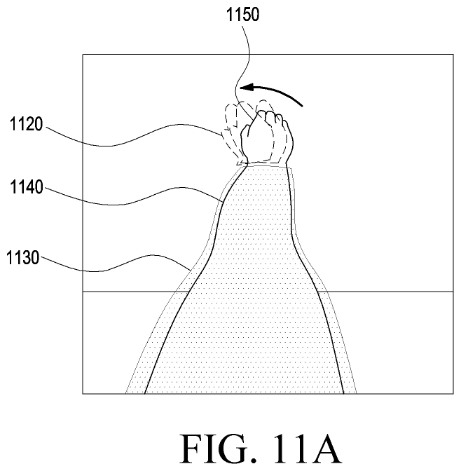

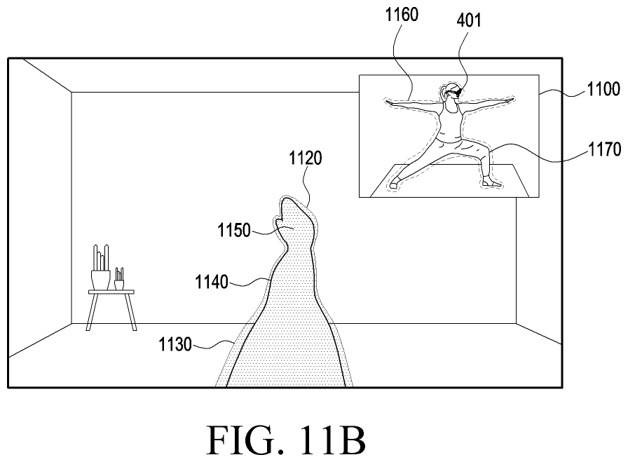

FIG. 11A is a view illustrating an operation of displaying feedback information using a first virtual object by a wearable electronic device according to an embodiment.

According to an embodiment, the wearable electronic device 401 (e.g., the wearable electronic device 401 of FIG. 5) may superimpose and display a first virtual object 1120 indicating a first designated exercise posture on the first body portion 1150 identified through the display 460. According to an embodiment, the first virtual object 1120 may include a virtual object based on information about the first body portion 1150. For example, the first body portion 1150 may include the user's right wrist. For example, the first designated posture may include a posture of moving the user's right wrist in a left direction.

According to an embodiment, the wearable electronic device 401 may identify the first matching degree between the first designated exercise posture and the first posture of the first body portion 1150. For example, the first matching degree may be obtained as a value of 0 to 100. According to an embodiment, the wearable electronic device 401 may identify the first matching degree based on at least one of the position of the first body portion 1150, the moving direction of the first body portion 1150, or the moving speed of the first body portion 1150, which is identified through the display 460. For example, the wearable electronic device 401 may compare the position of the first body portion 1150 identified through the display 460 with the display position of the first virtual object 1120 displayed to overlap at least a portion of the first body portion 1150. The wearable electronic device 401 may compare the moving direction of the first body portion 1150 with the moving direction of the first virtual object 1120. The wearable electronic device 401 may compare the moving speed of the first body portion 1150 with the moving speed of the first virtual object 1120.

According to an embodiment, when it is identified that the first matching degree is smaller than a first designated value, the wearable electronic device 401 may identify that the first designated exercise posture does not match the first posture.

According to an embodiment, the wearable electronic device 401 may display feedback information indicating that the first designated exercise posture does not match the first posture, using the first virtual object 1120. For example, the wearable electronic device 401 may display an arrow figure indicating the moving direction of the first designated exercise posture. For example, the wearable electronic device 401 may display a plurality of first virtual objects to indicate the moving direction of the first designated exercise posture. For example, the wearable electronic device 401 may display the first virtual object 1120 by dashed line. For example, the wearable electronic device 401 may apply a 3D effect in which the first virtual object moves from the right direction to the left direction.

According to an embodiment, when the posture of the arm 1140 of the user matches the designated exercise posture related to the arm 1140, the wearable electronic device 401 may apply a color or transparency different from that of the first virtual object 1120 to the virtual object 1130 indicating the designated exercise posture related to the posture of the arm 1140.

FIG. 11B is a view illustrating an operation of displaying feedback information using a first virtual object by a wearable electronic device according to an embodiment.

Referring to FIG. 11B, according to an embodiment, a wearable electronic device 401 (e.g., the wearable electronic device 401 of FIG. 5) may obtain an image 1100 captured while the user is performing a first posture from an external electronic device 501 (e.g., the external electronic device 501 of FIG. 5) and may display the image 1100.

According to an embodiment, the wearable electronic device 401 may display a virtual object 1160 indicating designated exercise postures on portions 1170 corresponding to body portions of the user included in the image 1100. For example, the virtual object 1160 may be displayed on at least some of the portions 1170 corresponding to the body portions.

According to an embodiment, the wearable electronic device 401 may identify that the first designated posture matches the first posture. According to an embodiment, the wearable electronic device 401 may display feedback information indicating that the first designated posture matches the first posture using the first virtual object 1120.

According to an embodiment, when the first designated posture to the first virtual object 1120 does not match the first posture, the wearable electronic device 401 may apply a color or transparency different from that applied to the first virtual object 1120.

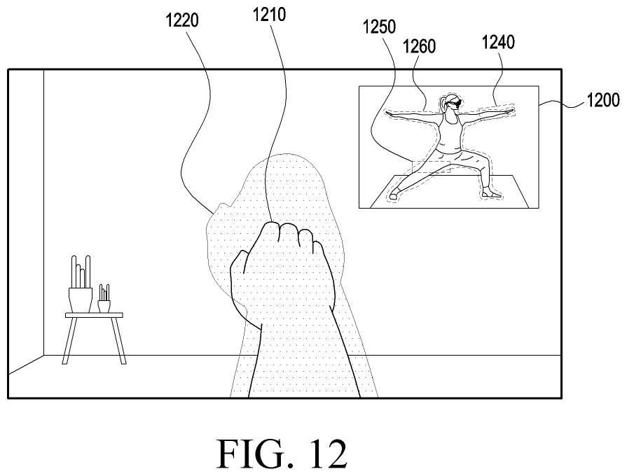

FIG. 12 is a view illustrating an operation of applying a visual effect to a portion of an image, corresponding to a first body portion, and a portion of the second image, corresponding to a second body portion, by a wearable electronic device according to an embodiment.

Referring to FIG. 12, according to an embodiment, a wearable electronic device 401 (e.g., the wearable electronic device 401 of FIG. 5) may obtain an image 1200 captured while the user is performing a first posture of a first body portion and a second posture of a second body portion from an external electronic device 501 (e.g., the external electronic device 501 of FIG. 5) and may display the image. For example, the image 1200 may include a left and right inverted image. For example, the first posture may include the posture of the first body portion, and the second posture may include the posture of the second body portion. For example, the first body portion may include the user's wrist and arm. For example, the second body portion may include the left thigh.

According to an embodiment, the first body portion may be positioned in the FOV area of the camera 410 (e.g., the camera 410 of FIG. 5), and the second body portion may be positioned in an area other than the FOV area of the camera 410.

According to an embodiment, the wearable electronic device 401 may display a virtual object 1260 indicating designated exercise postures on portions corresponding to body portions included in the image 1200.

According to an embodiment, the wearable electronic device 401 may display a first virtual object 1220 indicating a first designated posture on the first body portion 1210 positioned in the FOV area of the camera 410.

According to an embodiment, when it is identified that the first posture does not match the first designated posture, the wearable electronic device 401 may apply a visual effect to the portion 1240 corresponding to the first body portion included in the image 1200.

According to an embodiment, when it is identified that the first posture does not match the first designated posture, the wearable electronic device 401 may apply a visual effect to the portion 1240 corresponding to the first body portion included in the image 1200.

According to an embodiment, when it is identified that the second posture does not match the second designated posture, the wearable electronic device 401 may apply a visual effect to the portion 1250 corresponding to the second body portion included in the image 1200.

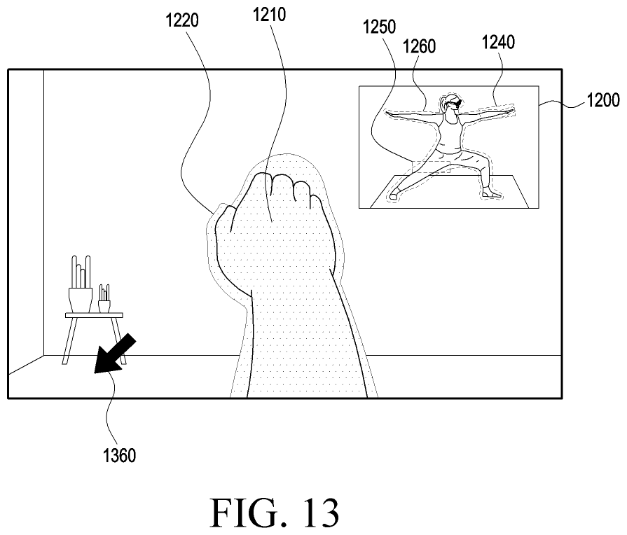

FIG. 13 is a flowchart illustrating an operation of displaying guide information to allow a second body portion to be positioned in an FOV area by a wearable electronic device according to an embodiment.

Referring to FIG. 13, according to an embodiment, the wearable electronic device 401 (e.g., the wearable electronic device 401 of FIG. 5) may display guide information 1360 for allowing the second body portion positioned in the area other than the FOV area of the user to be positioned in the FOV area of the camera 510 (e.g., the camera 510 of FIG. 5). For example, the guide information 1360 may include the direction in which the second body portion is positioned.

According to an embodiment, when the first posture of the first body portion positioned in the FOV area of the camera 510 matches the first designated posture, the wearable electronic device 401 may display guide information 1360 for allowing the second body portion positioned in the area other than the FOV area of the camera 510 to be positioned in the FOV area.

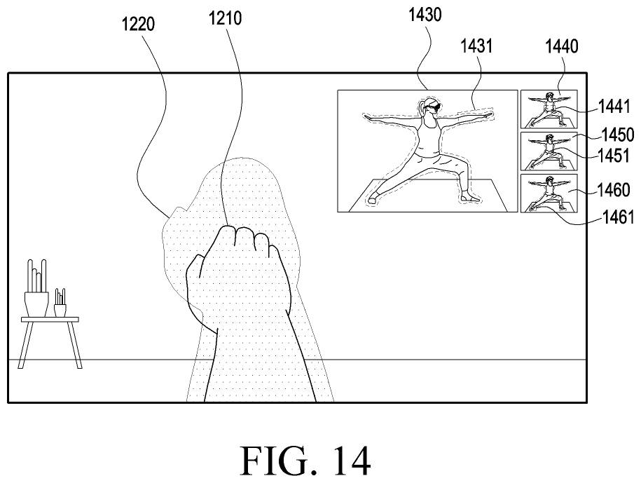

FIG. 14 is a view illustrating an operation of displaying a plurality of images by a wearable electronic device according to an embodiment.

Referring to FIG. 14, a wearable electronic device 401 (e.g., the wearable electronic device 401 of FIG. 5) may obtain, from an external electronic device 501 (e.g., the external electronic device 501 of FIG. 5), an image captured while the user performs postures of body portions at a first time.

According to an embodiment, the wearable electronic device 401 may display a plurality of images.

According to an embodiment, the wearable electronic device 401 may display images 1430, 1440, 1450, and 1460 in which the visual effects 1431, 1441, 1451, and 1461 are applied to the portions corresponding to the body portions, as it is identified that the postures of the user's body portions do not match the designated exercise postures related to the body portions.

According to an embodiment, the wearable electronic device 401 may determine the position at which each of the images 1430, 1440, 1450, and 1460 is displayed, based on the matching degree between the positions of the body portions and the respective designated exercise positions.

According to an embodiment, the wearable electronic device 401 may display the image 1430 corresponding to the lowest matching degree to be larger in size than the remaining images 1440, 1450, and 1460. According to an embodiment, the wearable electronic device 401 may display the image 1430 corresponding to the lowest matching degree relatively on the left side as compared with the remaining images 1440, 1450, and 1460.

According to an embodiment, the wearable electronic device 401 may display an image 1440 corresponding to the second lowest matching degree at an upper end of the display 460.

According to an embodiment, the wearable electronic device 401 may display an image 1450 corresponding to the third lowest matching degree at a lower end of the image 1440.

According to an embodiment, the wearable electronic device 401 may display an image 1460 corresponding to the highest matching degree at a lower end of the image 1450.

According to an embodiment, when it is identified that the first posture of the first body portion matches the first designated posture, the wearable electronic device 401 may not display the image 1430. According to an embodiment, the wearable electronic device 401 may display the image 1440 at the position where the image 1430 is displayed. According to an embodiment, the wearable electronic device 401 may increase the size of the image 1440.

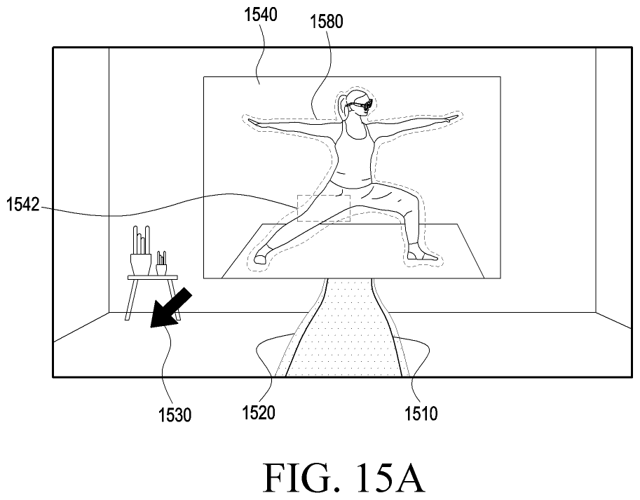

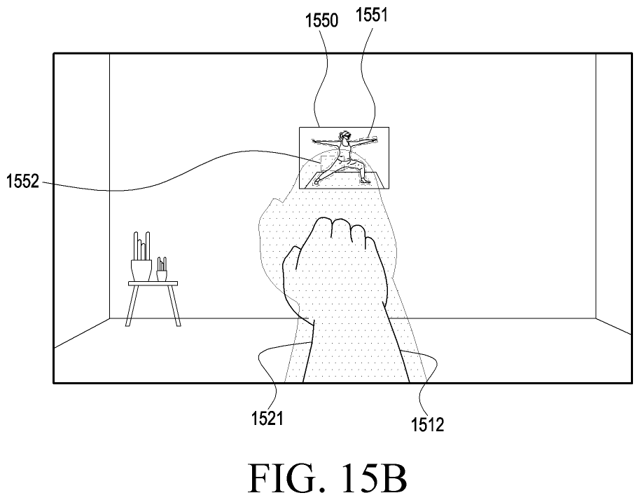

FIG. 15A is a view illustrating an operation of displaying an image when a first posture matches a first designated exercise posture, by a wearable electronic device according to an embodiment.

Referring to FIG. 15A, according to an embodiment, a wearable electronic device 401 (e.g., the wearable electronic device 401 of FIG. 5) may display a first virtual object 1520 indicating a first designated exercise posture on a first body portion 1510.

According to an embodiment, when the first designated exercise posture matches the first posture, the wearable electronic device 401 may determine whether the second posture matches the second designated posture.

According to an embodiment, when the second posture does not match the second designated posture, the wearable electronic device 401 may display guide information 1530 for allowing the second body portion positioned in an area other than the FOV area of the user to be positioned in the FOV area of the camera 510 (e.g., the camera 510 of FIG. 5).

According to an embodiment, when the first designated exercise posture matches the first posture, the wearable electronic device 401 may display the image 1540 obtained from the external electronic device 501 on the first virtual object or the first body portion.

According to an embodiment, the wearable electronic device 401 may display a virtual object 1580 indicating designated exercise postures on portions corresponding to body portions of the user included in the image 1540. According to an embodiment, the wearable electronic device 401 may apply a visual effect to a portion 1542 corresponding to the second body portion included in the image 1540.

FIG. 15B is a view illustrating an operation of displaying an image when a first posture does not match a first designated exercise posture, by a wearable electronic device according to an embodiment.

Referring to FIG. 15B, according to an embodiment, a wearable electronic device 401 (e.g., the wearable electronic device 401 of FIG. 5) may display a first virtual object 1521 indicating a first designated posture on a first body portion 1512.

According to an embodiment, when it is identified that the first posture of the first body portion 1512 does not match the first designated posture, the wearable electronic device 401 may reduce the size of the image 1550.

According to an embodiment, the wearable electronic device 401 may identify that the second posture of the second body portion does not match the second designated posture. According to an embodiment, the wearable electronic device 401 may not display guide information for allowing the second body portion positioned outside the FOV area of the user to be positioned in the FOV area until a time when it is identified that the first posture matches the first designated posture.

According to an embodiment, the wearable electronic device 401 may apply a visual effect to the portion 1551 corresponding to the first body portion and the portion 1552 corresponding to the second body portion included in the image 1550.

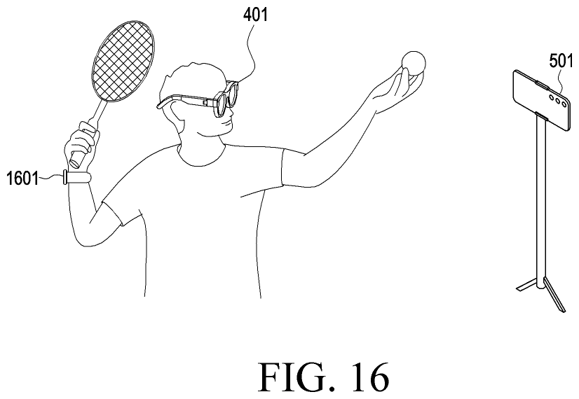

FIG. 16 is a view illustrating an operation of displaying feedback information based on sensing information received from a first wearable electronic device by a wearable electronic device according to an embodiment.

Referring to FIG. 16, according to an embodiment, a wearable electronic device 401 (e.g., the wearable electronic device 401 of FIG. 5) may establish a communication connection with a first wearable electronic device 1601. According to an embodiment, the first wearable electronic device 1601 may be implemented as a wearable electronic device wearable on a wrist.

According to an embodiment, the wearable electronic device 401 may obtain an image including body portions of the user from the external electronic device 501 (e.g., the external electronic device 501 of FIG. 5).

According to an embodiment, the wearable electronic device 401 may display a first virtual object indicating a first designated exercise posture on an image or a first body portion positioned in an FOV area of the camera 510 (e.g., the camera 510 of FIG. 5). For example, the first body portion may include the user's right wrist.

According to an embodiment, the first wearable electronic device 401 may obtain the moving speed of the first body portion using the sensor of the first wearable electronic device 401. According to an embodiment, the first wearable electronic device 401 may transmit the moving speed of the first body portion to the wearable electronic device 401.

According to an embodiment, the wearable electronic device 401 may identify whether the first designated exercise posture matches the first posture, based on the moving speed of the first body portion.

According to an embodiment, when the moving speed for the first designated exercise posture does not match the moving speed of the first body portion, the wearable electronic device 401 may transmit a control signal for allowing the first wearable electronic device 401 to output vibration. According to an embodiment, the first wearable electronic device 401 may output vibration. According to an embodiment, when the moving speed of the first body portion is smaller than the moving speed for the first designated exercise posture, the wearable electronic device 401 may output guide information for increasing the moving speed of the first body portion.

According to an embodiment, the first wearable electronic device 401 may obtain the heart rate of the user. According to an embodiment, the wearable electronic device 401 may obtain the heart rate from the first wearable electronic device 401. According to an embodiment, when it is identified that the heart rate is larger than a predetermined heart rate, the wearable electronic device 401 may display feedback information for resting.

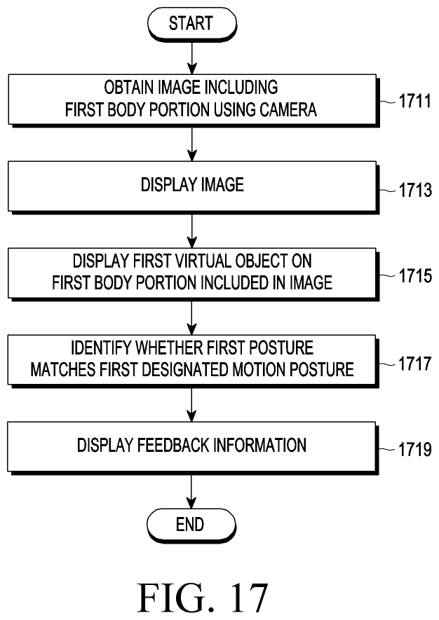

FIG. 17 is a flowchart illustrating an operation of displaying a first virtual object indicating a first designated exercise posture on a first body portion positioned in an FOV area by a wearable electronic device according to an embodiment.

Referring to FIG. 17, according to an embodiment, a wearable electronic device 401 (e.g., the wearable electronic device 401 of FIG. 5) may be implemented as a virtual reality (VR) device.

According to an embodiment, in operation 1711, the wearable electronic device 401 (e.g., the wearable electronic device 401 of FIG. 5) may obtain an image including the first body portion using the camera 410 (e.g., the camera 410 of FIG. 5). For example, the image may mean an image within an FOV area (e.g., an FOV area designated in the camera 410) of the camera 410 included in the wearable electronic device 401.

According to an embodiment, in operation 1713, the wearable electronic device 401 may display the captured image through a display (e.g., the display 460 of FIG. 5). For example, the wearable electronic device 401 may display an image captured through the camera 410 in real time.

According to an embodiment, in operation 1715, the wearable electronic device 401 may display, through the display 460, a first virtual object indicating a first designated exercise posture related to the first body portion on the first body portion of the user included in the image. For example, the wearable electronic device 410 may superimpose and display the first virtual object on a portion corresponding to the first body portion included in the image. For example, the wearable electronic device 401 may display a first virtual object whose transparency has been adjusted while overlapping the portion corresponding to the first body portion included in the image. For example, the wearable electronic device 401 may display a first virtual object in a translucent state on a portion corresponding to the first body portion included in the image.

According to an embodiment, in operation 1717, the wearable electronic device 401 may identify whether the first posture of the first body portion matches the first designated exercise posture. According to an embodiment, the wearable electronic device 401 may identify whether the first designated exercise posture matches the first posture, based on at least one of the position where the first body portion is displayed in the image, the moving direction of the first body portion, or the moving speed of the first body portion.

According to an embodiment, in operation 1719, the wearable electronic device 401 may display feedback information based on whether the first designated exercise posture matches the first posture. For example, the feedback information may be provided through visual, tactile, and/or auditory means.

According to an embodiment, when it is identified that the first designated exercise posture does not match the first posture, the wearable electronic device 401 may display first feedback information for correcting the first posture using the first virtual object.

According to an embodiment, when it is identified that the first designated exercise posture matches the first posture, the wearable electronic device 401 may display second feedback information indicating that the first posture matches the first designated exercise posture using the first virtual object.

According to an embodiment, the operations of the wearable electronic device 401 described with reference to FIGS. 1, 2, 3A, 3B, 4 to 6, 7A, 7B, 8, 9A, 9B, 10, 11A, 11B, 12 to 14, 15A, 15B, and 16 may be equally applied even when the wearable electronic device 401 is implemented as a VR device.

According to an embodiment, a wearable electronic device may comprise a camera, a display, communication circuitry, and a processor.

According to an embodiment, the wearable electronic device may obtain a first image captured by an external electronic device from the external electronic device through the communication circuit.

According to an embodiment, the first image may include an image captured for body portions of a user wearing the wearable electronic device.

According to an embodiment, the wearable electronic device may obtain exercise information about designated exercise postures using the body portions.

According to an embodiment, the wearable electronic device may obtain a second image through the camera.

According to an embodiment, the second image may include at least one body portion among the user's body portions.

According to an embodiment, the wearable electronic device may be based on identifying that the user's first body portion is positioned in a field of view (FOV) area of the camera using the first image and the second image, display, through the display, a first virtual object indicating a first designated exercise posture related to the first body portion among the designated exercise postures on a first area of the second image corresponding to the user's first body portion.

According to an embodiment, the wearable electronic device may identify whether the first designated exercise posture matches a first posture of the first body portion.

According to an embodiment, the wearable electronic device may display, through the display, first feedback information to correct the first posture using the first virtual object, based on identifying that the first designated exercise posture does not match the first posture.

According to an embodiment, the wearable electronic device may display, through the display, second feedback information indicating that the first posture matches the first designated exercise posture using the first virtual object, based on identifying that the first designated exercise posture matches the first posture.

According to an embodiment, the wearable electronic device may display the first image through the display.

According to an embodiment, the wearable electronic device may display virtual objects indicating the designated exercise postures on portions corresponding to the body portions included in the first image.

According to an embodiment, the wearable electronic device may identify, using at least one image from the external electronic device per a designated time, whether a second posture of the user's second body portion positioned in an area other than the FOV area matches a second designated exercise posture related to the second body portion among the designated exercise postures, and wherein the at least one image includes an image captured for the body portions of the user wearing the wearable electronic device.

According to an embodiment, the wearable electronic device may display guide information for positioning the second body portion in the FOV area based on identifying that the second posture does not match the second designated exercise posture.

According to an embodiment, the wearable electronic device may identify a first matching degree for the first designated exercise posture and the first posture.

According to an embodiment, the wearable electronic device may identify a second matching degree for the second designated exercise posture and the second posture.

According to an embodiment, the wearable electronic device may compare the first matching degree with the second matching degree.

According to an embodiment, the wearable electronic device may obtain a third image captured for the user's body portions in a state in which the user performs the first posture and the second posture from the external electronic device.

According to an embodiment, the wearable electronic device may apply a visual effect to an area of the third image corresponding to the first body portion based on identifying that the first matching degree is lower than the second matching degree while displaying the third image through the display.

According to an embodiment, the wearable electronic device may compare a moving direction of the first body portion with a moving direction of the first designated exercise posture.

According to an embodiment, the wearable electronic device may compare a moving speed of the first body portion with a moving speed of the first designated exercise posture.

According to an embodiment, the wearable electronic device may identify whether the first designated exercise posture matches the first posture based on the comparison between the moving directions and the comparison between the moving speeds.

According to an embodiment, in the wearable electronic device, the first designated exercise posture may include a dynamic exercise posture.

According to an embodiment, the wearable electronic device may adjust the moving speed of the first designated exercise posture based on identifying that the first designated exercise posture does not match the first posture.

According to an embodiment, in the wearable electronic device, the designated exercise postures may include designated exercise postures sequentially performed.

According to an embodiment, the wearable electronic device may display a third virtual object indicating a third designated exercise posture after the first designated motion posture related to the first body portion, on the first area of the second image corresponding to the first body portion, based on identifying that the first posture matches the first designated exercise posture.

According to an embodiment, the wearable electronic device may display a second virtual object indicating the second designated exercise posture, on a second area of the second image corresponding to the second body portion, based on identifying that the second body portion is positioned in the FOV area using the first image and the second image.

According to an embodiment, a method for operating a wearable electronic device may comprise obtaining a first image captured by an external electronic device from the external electronic device.

According to an embodiment, in the method for operating the wearable electronic device, the first image may include an image captured for body portions of a user wearing the wearable electronic device.

According to an embodiment, the method for operating the wearable electronic device may comprise obtaining exercise information about designated exercise postures using the body portions from the external electronic device.

According to an embodiment, the method for operating the wearable electronic device may comprise obtaining a second image through a camera included in the wearable electronic device.

According to an embodiment, the method for operating the wearable electronic device may comprise based on identifying that the user's first body portion is positioned in a field of view (FOV) area of the camera using the first image and the second image, displaying a first virtual object indicating a first designated exercise posture related to the first body portion among the designated exercise postures on a first area of the second image corresponding to the user's first body portion.

According to an embodiment, the method for operating the wearable electronic device may comprise identifying whether the first designated exercise posture matches a first posture of the first body portion.

According to an embodiment, the method for operating the wearable electronic device may comprise displaying, through the display, first feedback information to correct the first posture using the first virtual object, based on identifying that the first designated exercise posture does not match the first posture.

According to an embodiment, the method for operating the wearable electronic device may comprise displaying, through the display, second feedback information indicating that the first posture matches the first designated exercise posture using the first virtual object, based on identifying that the first designated exercise posture matches the first posture.

According to an embodiment, the method for operating the wearable electronic device may comprise displaying the first image through a display.

According to an embodiment, the method for operating the wearable electronic device may comprise displaying virtual objects indicating the designated exercise postures on areas of the first image corresponding to the body portions included in the first image.

According to an embodiment, the method for operating the wearable electronic device may comprise identifying whether a second posture of the user's second body portion positioned in an area other than the FOV area matches a second designated motion posture related to the second body portion among the designated exercise postures, and wherein the at least one image includes an image captured for the body portions of the user wearing the wearable electronic device.

According to an embodiment, the method for operating the wearable electronic device may comprise displaying guide information for positioning the second body portion in the FOV area based on identifying that the second posture does not match the second designated exercise posture.

According to an embodiment, the method for operating the wearable electronic device may comprise identifying a first matching degree for the first designated exercise posture and the first posture.

According to an embodiment, the method for operating the wearable electronic device may comprise identifying a second matching degree for the second designated exercise posture and the second posture.

According to an embodiment, the method for operating the wearable electronic device may comprise comparing the first matching degree with the second matching degree.

According to an embodiment, the method for operating the wearable electronic device may comprise obtaining a third image captured for the user's body portions in a state in which the user performs the first posture and the second posture from the external electronic device.

According to an embodiment, the method for operating the wearable electronic device may comprise applying a visual effect to an area of the third image corresponding to the first body portion included in the third image based on identifying that the first matching degree is lower than the second matching degree while displaying the third image through the display.

According to an embodiment, the method for operating the wearable electronic device may comprise comparing a moving direction of the first body portion with a moving direction of the first designated exercise posture.

According to an embodiment, the method for operating the wearable electronic device may comprise comparing a moving speed of the first body portion with a moving speed of the first designated exercise posture.

According to an embodiment, the method for operating the wearable electronic device may comprise identifying whether the first designated exercise posture matches the first posture based on the comparison between the moving directions and the comparison between the moving speeds.

According to an embodiment, in the method for operating the wearable electronic device, the first designated exercise posture may include a dynamic exercise posture.

According to an embodiment, the method for operating the wearable electronic device may comprise adjusting the moving speed of the first designated exercise posture based on identifying that the first designated exercise posture does not match the first posture.

According to an embodiment, the method for operating the wearable electronic device may comprise displaying a second virtual object indicating the second designated exercise posture, on a second area of the second image corresponding to the second body portion, based on identifying that the second body portion is positioned in the FOV area using the first image and the second image.

According to an embodiment, a non-transitory recording medium may comprise at least one instruction capable of executing obtaining a first image captured by an external electronic device from the external electronic device.

According to an embodiment, the non-transitory recording medium may comprise at least one instruction capable of executing obtaining exercise information about designated exercise postures using the body portions from the external electronic device.

According to an embodiment, the non-transitory recording medium may comprise at least one instruction capable of executing obtaining a second image through a camera included in the wearable electronic device.

According to an embodiment, the non-transitory recording medium may comprise at least one instruction capable of executing based on identifying that the user's first body portion is positioned in a field of view (FOV) area of the camera using the first image and the second image, displaying a first virtual object indicating a first designated exercise posture related to the first body portion among the designated exercise postures on a first area of the second image corresponding to the user's first body portion.

According to an embodiment, the non-transitory recording medium may comprise at least one instruction capable of executing identifying whether the first designated exercise posture matches a first posture of the first body portion.

According to an embodiment, the non-transitory recording medium may comprise at least one instruction capable of executing displaying, through the display, first feedback information to correct the first posture using the first virtual object, based on identifying that the first designated exercise posture does not match the first posture.

According to an embodiment, the non-transitory recording medium may comprise at least one instruction capable of executing displaying, through the display, second feedback information indicating that the first posture matches the first designated exercise posture using the first virtual object, based on identifying that the first designated exercise posture matches the first posture.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic device is not limited to the above-listed embodiments.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101, 200, 300, or 501). For example, a processor (e.g., the processor 120, 420, or 520) of the machine (e.g., the electronic device 101, 200, 300, 401, or 501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A wearable electronic device comprising:
a camera;
a display;
communication circuitry;
at least one processor; and
memory storing instructions, that, when executed by the at least one processor individually or collectively, cause the wearable electronic device to:
obtain, through the communication circuitry, a first image captured by an external electronic device from the external electronic device, wherein the first image includes an image captured for body portions of a user wearing the wearable electronic device,
obtain exercise information about designated exercise postures using the body portions,
obtain, through the camera, a second image, wherein the second image includes at least one body portion among the body portions of the user,
based on identifying that a first body portion of the user is positioned in a field of view (FOV) area of the camera using the first image and the second image, display, through the display, a first virtual object indicating a first designated exercise posture related to the first body portion among the designated exercise postures on a first area of the second image corresponding to the first body portion of the user,
identify whether the first designated exercise posture matches a first posture of the first body portion of the user,
display, through the display, first feedback information to correct the first posture using the first virtual object, based on identifying that the first designated exercise posture does not match the first posture, and
display, through the display, second feedback information indicating that the first posture matches the first designated exercise posture using the first virtual object, based on identifying that the first designated exercise posture matches the first posture.

2. The wearable electronic device of claim 1, wherein the instructions that, when executed by the at least one processor individually or collectively, cause the wearable electronic device to:
display, through the display, the first image; and
display virtual objects indicating the designated exercise postures on areas of the first image corresponding to the body portions.

3. The wearable electronic device of claim 1,
wherein the instructions that, when executed by the at least one processor individually or collectively, cause the wearable electronic device to,
identify, using at least one image from the external electronic device per a designated time, whether a second posture of a second body portion of the user positioned in an area other than the FOV area matches a second designated exercise posture related to the second body portion among the designated exercise postures, and
wherein the at least one image includes an image captured for the body portions of the user wearing the wearable electronic device.

4. The wearable electronic device of claim 3, wherein the instructions that, when executed by the at least one processor individually or collectively, cause the wearable electronic device to, display guide information for positioning the second body portion in the FOV area based on identifying that the second posture does not match the second designated exercise posture.

5. The wearable electronic device of claim 3, wherein the instructions that, when executed by the at least one processor individually or collectively, cause the wearable electronic device to:
identify a first matching degree for the first designated exercise posture and the first posture;
identify a second matching degree for the second designated exercise posture and the second posture; and
compare the first matching degree with the second matching degree.

6. The wearable electronic device of claim 5, wherein the instructions that, when executed by the at least one processor individually or collectively, cause the wearable electronic device to:
obtain a third image captured for the body portions of the user in a state in which the user performs the first posture and the second posture from the external electronic device; and
apply a visual effect to an area of the third image corresponding to the first body portion based on identifying that the first matching degree is lower than the second matching degree while displaying the third image through the display.

7. The wearable electronic device of claim 5, wherein the instructions that, when executed by the at least one processor individually or collectively, cause the wearable electronic device to:
compare a moving direction of the first body portion with a moving direction of the first designated exercise posture,
compare a moving speed of the first body portion with a moving speed of the first designated exercise posture, and
identify whether the first designated exercise posture matches the first posture based on the comparison between the moving directions and the comparison between the moving speeds, and
wherein the first designated exercise posture includes a dynamic exercise posture.

8. The wearable electronic device of claim 1,
wherein the first designated exercise posture includes a dynamic exercise posture, and
wherein the instructions that, when executed by the at least one processor individually or collectively, cause the wearable electronic device to adjust a moving speed of the first designated exercise posture based on identifying that the first designated exercise posture does not match the first posture.

9. The wearable electronic device of claim 1,
wherein the designated exercise postures include designated exercise postures to be performed sequentially, and
wherein the instructions that, when executed by the at least one processor individually or collectively, cause the wearable electronic device to display a third virtual object indicating a third designated exercise posture after the first designated exercise posture related to the first body portion, on the first area of the second image corresponding to the first body portion, based on identifying that the first posture matches the first designated exercise posture.

10. The wearable electronic device of claim 3,
wherein the instructions that, when executed by the at least one processor individually or collectively, cause the wearable electronic device to display a second virtual object indicating the second designated exercise posture, on a second area of the second image corresponding to the second body portion, based on identifying, using the first image and the second image, that the second body portion is positioned in the FOV area.

11. A method for operating a wearable electronic device, the method comprising:
obtaining a first image captured by an external electronic device from the external electronic device, wherein the first image includes an image captured for body portions of a user wearing the wearable electronic device;
obtaining exercise information about designated exercise postures using the body portions;
obtaining a second image through a camera included in the wearable electronic device, wherein the second image includes at least one body portion among the user's body portions;
based on identifying that a first body portion of the user is positioned in a field of view (FOV) area of the camera using the first image and the second image, displaying, through a display included in the wearable electronic device, a first virtual object indicating a first designated exercise posture related to the first body portion among the designated exercise postures on a first area of the second image corresponding to the first body portion of the user;
identifying whether the first designated exercise posture matches a first posture of the first body portion of the user;
displaying, through the display, first feedback information to correct the first posture using the first virtual object, based on identifying that the first designated exercise posture does not match the first posture; and
displaying, through the display, second feedback information indicating that the first posture matches the first designated exercise posture using the first virtual object, based on identifying that the first designated exercise posture matches the first posture.

12. The method of claim 11, further comprising:
displaying the first image; and
displaying virtual objects indicating the designated exercise postures on areas of the first image corresponding to the body portions included in the first image.

13. The method of claim 11, further comprising identifying, using at least one image from the external electronic device per a designated time, whether a second posture of a second body portion of the user positioned in an area other than the FOV area matches a second designated exercise posture related to the second body portion among the designated exercise postures, and
wherein the at least one image includes an image captured for the body portions of the user wearing the wearable electronic device.

14. The method of claim 13, further comprising displaying guide information for positioning the second body portion in the FOV area based on identifying that the second posture does not match the second designated exercise posture.

15. The method of claim 13, further comprising:
identifying a first matching degree for the first designated exercise posture and the first posture;
identifying a second matching degree for the second designated exercise posture and the second posture; and
comparing the first matching degree with the second matching degree.

16. The method of claim 15, further comprising:
obtaining a third image captured for the body portions of the user in a state in which the user performs the first posture and the second posture from the external electronic device; and
applying a visual effect to an area of the third image corresponding to the first body portion based on identifying that the first matching degree is lower than the second matching degree while displaying the third image.

17. The method of claim 11, further comprising:
comparing a moving direction of the first body portion with a moving direction of the first designated exercise posture;
comparing a moving speed of the first body portion with a moving speed of the first designated exercise posture; and
identifying whether the first designated exercise posture matches the first posture based on the comparison between the moving directions and the comparison between the moving speeds,
wherein the first designated exercise posture includes a dynamic exercise posture.

18. The method of claim 17, further comprising:
adjusting the moving speed of the first designated exercise posture based on identifying that the first designated exercise posture does not match the first posture,
wherein the first designated exercise posture includes a dynamic exercise posture.

19. The method of claim 13, further comprising:
displaying a second virtual object indicating the second designated exercise posture, on a second area of the second image corresponding to the second body portion, based on identifying, using the first image and the second image, that the second body portion is positioned in the FOV area.

20. A storage medium storing computer-readable instructions, the instructions, when executed by at least one processor of a wearable electronic device individually or collectively, cause the wearable electronic device to perform operations, the operations comprising:
obtaining a first image captured by an external electronic device from the external electronic device, wherein the first image includes an image captured for body portions of a user wearing the wearable electronic device;
obtaining exercise information about designated exercise postures using the body portions;
obtaining a second image through a camera included in the wearable electronic device, wherein the second image includes at least one body portion among the user's body portions;
based on identifying that a first body portion of the user is positioned in a field of view (FOV) area of the camera using the first image and the second image, displaying, through a included in the wearable electronic device, a first virtual object indicating a first designated exercise posture related to the first body portion among the designated exercise postures on a first area of the second image corresponding to the first body portion of the user;
identifying whether the first designated exercise posture matches a first posture of the first body portion of the user;
displaying, through the display, first feedback information to correct the first posture using the first virtual object, based on identifying that the first designated exercise posture does not match the first posture; and
displaying, through the display, second feedback information indicating that the first posture matches the first designated exercise posture using the first virtual object, based on identifying that the first designated exercise posture matches the first posture.
